(19) United States
(12) Patent Application Publication
(10) Pub. No.: US 2026/0296985 A1
(43) Pub. Date: Oct. 1, 2026

(54) WATER INSOLUBLE POLYPHOSPHATE FERTILIZERS

(71) Applicant: Agtec Innovations, Inc., Los Altos, CA (US)

(72) Inventor: Chandrika VARADACHARI, Kolkata (IN)

(21) Appl. No.: 19/478,589

(22) PCT Filed: Apr. 24, 2024
(86) PCT No.: PCT/IN2024/050439

§ 371 Date: Oct. 24, 2025

(30) Foreign Application Priority Data
Apr. 28, 2023 (IN) 202331030575

(51) Int. Cl. C05B 17/02

(52) U.S. Cl. CPC C05B 17/02

(57) ABSTRACT

Fertilizer compositions for micronutrients and phosphates based on polyphosphate compositions of Zn, Fe, Mn, Cu, B and Mo and basic cations Ca, Mg, K and NH₄⁺ that have narrowly defined range of chain lengths for optimized performance, low water soluble phosphorous and high levels of solubility in 0.1N NaHCO₃ and Morgan's extractant.

### FIELD OF THE INVENTION

The present invention relates generally to polyphosphate fertilizers and, in particular, to water-insoluble polyphosphate fertilizers optionally containing micronutrient quantities of zinc, iron, manganese, copper, boron, and molybdenum. The disclosed solid polyphosphate fertilizers possess chain length and solubility properties enabling optimal performance benefits.

### BACKGROUND

Water soluble fertilizers are leached into water bodies thereby resulting in fertilizer losses, creating water pollution, reducing fertilizer efficiency. To improve environmental friendliness of fertilizers it is advantageous to make them water-insoluble. Water-insoluble phosphates provide a framework for producing water-insoluble forms of micronutrient fertilizers as well as for producing water-insoluble phosphate fertilizers. Such water-soluble fertilizers can be made plant available by controlling their solubility in organic acids (Ray et al 1972) such as citric acid, DTPA, EDTA etc.

Micronutrient polyphosphate compositions in powder form that are sparingly or even insoluble in water but soluble in organic acids have been described in the literature for use as fertilizers for crops. See, e.g., U.S. Pat. Nos. 7,670,405, 7,691,171, 8,216,337, 8,506,670, 8,999,031, 9,017,443, and 9,181,137 and Ray et al., Ind. Eng. Chem. Res. 1993, 32, 1218-1227. For example, U.S. Pat. No. 8,506,670 describes micronutrient polyphosphates that are reported to be soluble in 2% citric acid and having a chain length in the range of 1.5 to 30. While such polyphosphates represent a significant advance over prior polyphosphate fertilizer compositions, their dissolution characteristics in organic acids permitted room for further improvement with respect to crop yield benefits.

### BRIEF SUMMARY

Among the various aspects of the present disclosure is the provision of polyphosphate fertilizers containing one or more of the micronutrients, Zn, Fe, Mn, Cu, B, and Mo that are water-insoluble, with high efficiency and performance and are defined by a narrow range of chain length and solubility properties that distinguish polyphosphate fertilizers of the present disclosure from products of lesser performance. These polyphosphates are characterized by reduced water-soluble phosphorous, greater 0.1N NaHCO₃ soluble phosphorous and Morgan's extractant (sodium acetate-acetic acid at pH 4.8), a narrow range of number average chain length of P in the polyphosphate and the monomer content (orthophosphate). Moreover, the polyphosphate fertilizers of the present disclosure are characterized by a narrow range of polyphosphate chain lengths for highest nutrient availability and, advantageously, may be prepared by a method that offers energy savings compared to previously disclosed methods.

Briefly, therefore, the present disclosure describes water-insoluble polyphosphate fertilizer compositions of Zn, Fe, Mn, Cu, B, and Mo that contain one or more of Ca, Mg, K and NH₄⁺, have increased availability of nutrients with optimized number average chain lengths in the range of 1.2 to 2.5, monomer content (orthophosphate) at least 40%, high solubility in a 0.1N NaHCO₃ and in Morgan's extractant (0.72 N CH₃COONa+0.52 N CH₃COOH at pH 4.8). This composition is produced by a method that results in energy savings. Products having such characteristics have been observed to produce substantial yield increases in field crops.

### BRIEF DESCRIPTION OF THE DRAWINGS

FIGS. 1A-1D show a correlation between solubility in Morgan's extractant (in a Morgan Assay) and percent yield increase with respect to control for zinc polyphosphates (A, potato; B, rice) and calcium polyphosphates (C, cabbage; D, potato). The numbers next to data points indicate the sample numbers from the examples. Encircled data points show the products of this disclosure.

FIG. 2 is correlation between percent total phosphorous, P, soluble in Morgan's extractant (Morgan Assay) and a ratio, OP/ñ′, of orthophosphate wt %, OP, and number average chain length, including orthophosphate, for zinc polyphosphate compositions prepared as further described in the Examples. Encircled data points show the products of this disclosure.

FIG. 3A is a ³¹P NMR of a zinc polyphosphate composition prepared as described in Example 8 and a zinc polyphosphate prepared in accordance with Comparative Example 20.4b and FIG. 3B is a ³¹P NMR of a manganese polyphosphate composition prepared as described in Example 17; inlet figure shows a magnified view of the peak near −7.4 ppm.

FIG. 4 is a plot of chain length titrations for the zinc polyphosphate composition prepared as described in Example 8.

### DEFINITIONS AND ASSAYS

Unless otherwise stated, all percentages recited herein are percentages by weight.

As used herein and unless stated otherwise, the term “basic cation” shall mean a cation selected from the group consisting of ammonium, calcium, magnesium, potassium, and the combinations thereof.

As used herein and unless stated otherwise, the term “micronutrient metal” shall mean a metal selected from the group consisting of boron, copper, iron, manganese, molybdenum and zinc, and combinations thereof.

As used herein and unless stated otherwise, the term “chain length” or the equivalent shall mean the number average chain length of a polyphosphate composition including orthophosphate.

As used herein, ñ′ is the number average chain length of the polyphosphate including orthophosphate and ñ is the number average chain length of the polyphosphate excluding orthophosphate.

As used herein and unless stated otherwise, the term “orthophosphate content” when used in combination with a numerical value shall mean the weight percentage of total phosphate as orthophosphate in a polyphosphate composition.

As used herein, a Morgan Assay comprises weighing 100 mg of product (passed through a 180 micron sieve) into an Erlenmeyer flask, adding 50 mL of Morgan's extractant consisting of a solution of 0.72 N NaOAc+0.52 N CH3COOH at pH 4.8 (Lunt et al. 1958) at 30° C., shaking in a horizontal shaker for 15 min, filtering, washing making up to volume, taking an aliquot in a volumetric flask, adding 10 mL concentrated HCl to it, digesting over a hot plate for 15 min, cooling, making up to volume and analyzing P as molybdovanadophosphate (AOAC 1990, assay no. 958.01).

As used herein, a Water Solubility Assay for micronutrient metals comprises weighing 500 mg of product (passed through a 180 micron sieve), into an Erlenmeyer flask adding 50 mL double distilled water at 30° C. to it, shaking on a horizontal shaker for 30 min, filtering, washing, adding 2 mL concentrated HCl, making up to volume and analyzing the Zn, Cu, Ca, Mg, K and/or Mo content by AAS (atomic absorption spectroscopy) (AOAC 1990), Fe content colorimetrically as the red o-phenanthroline complex (Mendham et al., 2006), Mn colorimetrically as the permanganate after oxidation with KIO₃ (Maxwell 1968), B as the 1,1′-dianthrimide in concentrated sulfuric acid (Jeffrey et al. 1989).

As used herein, the Water Solubility Assay for P comprises weighing 500 mg of product (passed through a 180-micron sieve), into an Erlenmeyer flask adding 50 mL double distilled water at 30° C. to it, shaking on a horizontal shaker for 30 min, filtering, washing, making to volume, digesting an aliquot with 5 mL HCl to its boiling point over a hotplate for 15 min and analyzing P in the extract spectrophotometrically as the molybdovanadophosphate (AOAC 1990, assay no. 958.01).

As used herein, the assay for total phosphate comprises weighing 100 mg of product (passed through a 180-micron sieve) into an Erlenmeyer flask, adding 10 mL concentrated HCl to it, digesting over a hot plate for 15 min, cooling, making up to volume and analyzing P as molybdovanadophosphate (AOAC 1990, assay no. 958.01).

As used herein, the assay for total Zn, Fe, Mn, Cu, B, Mo, Ca, Mg and/or K comprises weighing 100 mg of product (passed through a 180-micron sieve) into an Erlenmeyer flask, adding 10 mL concentrated HCl to it, digesting over a hot plate for 15 min, cooling, making up to volume and analyzing micronutrients and basic cations as described above in connection with the Water Solubility Assay for micronutrient materials.

As used herein, the Bicarbonate Assay comprises weighing 100 mg of product (passed through a 180-micron sieve) into an Erlenmeyer flask, adding 50 mL 0.1N NaHCO3 at 30 C to it, shaking the suspension for 60 min on a horizontal shaker, filtering, washing, making up to volume, taking an aliquot in a volumetric flask, adding 10 mL concentrated HCl to it, digesting over a hot plate for 15 min, cooling, making up to volume and analyzing P as molybdovanadophosphate (AOAC 1990, assay no. 958.01).

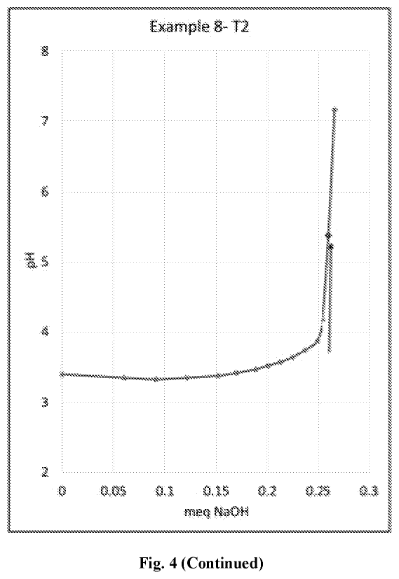

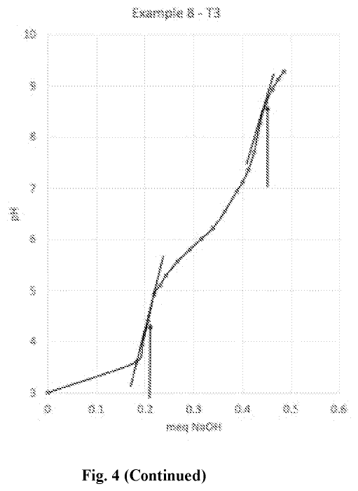

As used herein, the assay for the chain length and orthophosphate content comprises taking 30 g of a strong acid cation exchange resin (Amberlite IR 120) in an Erlenmeyer flask, converting it to a H-form by treatment with 80 mL of 0.1 N HCl, shaking it for 15 min in a horizontal shaker, washing it free of Cl⁻ with repeated washing for 25 times with 20 mL portions of double distilled water, adding 1 g product (passed through a 180-micron sieve) to the resin suspension, placing on a shaker for 5 min, decanting through a Whatman 1 filter paper placed over a 100 mL volumetric flask, making up to volume, then (a) immediately pipetting 10 mL of the solution into a 50-mL beaker and adding 10 mL water, stirring the solution and immediately titrating he solution in a pH-meter with slow, dropwise addition of 0.1N NaOH as described by Van Wazer et al. (1954, 1966) to a pH of 10 (titration 1) so that the end point is detected within ±1 drop of NaOH, followed by (b) lowering the pH of the same solution to pH around 3 by addition of 0.1N HNO₃, adding 2 mL of freshly prepared 0.1N AgNO₃ solution and titrating again to an end point at around pH 7-8 (titration 2), and finally (c) taking another 5 mL aliquot of the same solution in a Ni crucible, adding 2 beads of NaOH (300 mg) to it, drying it slowly (for 90 min) over a hotplate (to avoid boiling and solution loss), finally heating the contents till NaOH has melted (fused), cooling the crucible and its contents to RT, adding 5 mL water to dissolve the contents, quantitatively transferring the contents to a solution of 1.5 mL concentrated HCl in 10 mL water, transferring this solution quantitatively into a 100 mL volumetric flask, making up to volume and determining total P by the same pH-metric titration process (titration 3) to an end point around pH 5-6, where the meq of NaOH (normality of NaOH×volume of NaOH) required for the titrations 1-3 is determined from (a) the amount of NaOH required to titrate from the first endpoint around pH 4.5 to the second endpoint near pH 9 for titration-1 is say T1, and this value is the amount of end group P (EP), (b) the amount of NaOH required to titrate the solution after addition of AgNO₃ to the endpoint near pH 6 for titration-2 is say T2, and amount of orthophosphate (OP) is obtained from the value of T2 minus the base consumed in T1, i.e., orthophosphate P, OP=(T2−T1) meq (c) the amount of NaOH required to titrate from the first endpoint around pH 4.5 to the second endpoint near pH 8-9 for titration-3 is say T3, and total P (TP) is obtained as 2×T3, and the value of average number of P atoms per chain (ñ) is evaluated as ñ=[{2(total P−orthophosphate P)}]/(end group P−orthophosphate P)}] or ñ=[{2(TP−OP)}]/(EP−OP)], where this value of ñ excludes the orthophosphate and if the ortho group is to be included in the value, then ñ′ (including ortho)=[ñ/{o (ñ−1)+1}] (Van Wazer, 1954, 1966), where OP=mole fraction of total P as orthophosphate. An illustrative example of the three titrations is shown in FIG. 4. Titration 2 with silver nitrate is strongly influenced by the formation of Ag⁺ ions in AgNO₃ solution that has aged and will give serious error. The titration 2 is to be performed slowly to allow for neutralization of H⁺ ions adsorbed on the surface of silver phosphate precipitate; pH readings must be checked to verify that this equilibrium has attained. Titration 1 must be performed with sufficient concentration of P in the solution and in the amounts and dilutions described here. Excess dilution of the sample will give poor pH change and erroneous data.

As used herein, the assay for the Citric Acid Solubility Assay comprises weighing 50 mg fertilizer (passed through a 180-micron sieve) into a stoppered 250 mL Erlenmeyer flask, adding 50 mL of 2 wt % citric acid, placing the suspension in a horizontal shaker for 15 min, filtering, washing, and making up to volume in a volumetric flask and analyzing for metal ions as described in a Water Solubility Assay.

As used herein, the assay for total nitrogen is obtained by Kjeldahl's method (AOAC 1990, assay no. 978.02) using product passed through a 180-micron sieve.

As used herein, assay for ³¹P NMR of zinc polyphosphate was a solid-state MAS spectra at 10 kHz and manganese polyphosphate was a solid-state MAS spectra at 12 kHz using ammonium dihydrogen orthophosphate as reference standard.

### DETAILED DESCRIPTION

Metal polyphosphates of all degrees of chain lengths, starting from the very smallest chain pyrophosphates (two phosphorous atoms per chain) to infinite chain metaphosphates have low water solubility. Some of the smaller chain polyphosphates are soluble in chelating agents like citric acid, DTPA, EDTA, etc. but solubility in such reagents decreases as chain length increases. Even in dilute, 2% citric acid, many types of polyphosphates are soluble; for example, orthophosphates, pyrophosphate, tripolyphosphate are soluble in 2% citric acid. Not all of these polyphosphates, however, are suitable fertilizers. To distinguish polyphosphates that are more efficient from those that are less efficient, it is required to define polyphosphates more narrowly in terms of their solubility and chain length. Sodium bicarbonate (NaHCO₃) solubility is one index that is used by soil scientists to estimate P availability. Another index is solubility in Morgan's extractant (0.72 N CH₃COONa+0.52 N CH₃COOH at pH 4.8), that is used to measure various available nutrients in soil. To obtain polyphosphates with optimum nutrient availability, polyphosphates were developed which had highest solubility in bicarbonate and Morgan's extractant.

An improved polyphosphate composition is defined in the present disclosure with respect to its chain length, orthophosphate content, solubility in a 0.1N NaHCO₃ and solubility in Morgan's extractant. While it has been observed that orthophosphate content is necessary for increased solubility in bicarbonate, 100% orthophosphate is not favorable. Based upon experimental evidence to-date, the optimum level is around 50% orthophosphate. Both orthophosphate as well as the dimers and trimers (pyrophosphate and tripolyphosphates) have low solubility in Morgan's extractant, but compounds of intermediate chain lengths containing ortho as well as small chain polyphosphates have higher solubility. Without being bound by any particular theory and based upon experimental evidence, to-date, it appears that orthophosphates and polyphosphates in combination produce a 3-dimensional crystalline structure, thereby optimizing the solubility properties for higher nutrient release characteristics. Stated differently, it appears the incorporation of orthophosphate into the structure modulates the properties to favor nutrient dissolution. Highest solubility in NaHCO₃ was shown by polyphosphates with number average chain length of P between 1.6 and 1.9. Such products showed P solubility of 58% to 60% in NaHCO₃. On the contrary the solubility of orthophosphate was less than 45% and that of pyrophosphate and tripolyphosphate was about 30%.

### Phosphate Fertilizer

In one embodiment, the polyphosphate composition of the present disclosure is a polyphosphate fertilizer containing calcium as a basic cation (as described elsewhere herein) and at least 0.1 wt % and less than 2 wt % (combined total) of metals selected from the group consisting of Zn, Fe, Mn, Cu, B, and Mo, and combinations thereof. For example, in one such embodiment, the combined total of metals selected from the group consisting of Zn, Fe, Mn, Cu, B, and Mo comprised by the polyphosphate is less than 1.5 wt %. By way of further example, in one such embodiment, the combined total of metals selected from the group consisting of Zn, Fe, Mn, Cu, B, and Mo comprised by the polyphosphate is less than 1 wt %.

### Micronutrient Fertilizer

In one embodiment, the polyphosphate composition comprises one or more metals such as Zn, Fe, Mn, Cu, B or Mo as a micronutrient. In general, in such embodiments the polyphosphate composition comprises at least 0.1 wt % (combined total) of metal(s) selected from the group consisting of Zn, Fe, Mn, Cu, B and Mo, and combinations thereof. For example, in such embodiments the polyphosphate composition may comprise at least 1 wt % (combined total) of metal(s) selected from the group consisting of Zn, Fe, Mn, Cu, B and Mo, and combinations thereof. By way of further example, in such embodiments the polyphosphate composition comprises at least 2 wt % (combined total) and up to about 30 wt % (combined total) of metal(s) selected from the group consisting of Zn, Fe, Mn, Cu, B and Mo, and combinations thereof. For example, in some embodiments the polyphosphate will contain at least 3 wt % (combined total) and up to about 25 wt % (combined total) of a metal selected from the group consisting of Zn, Fe, Mn, Cu, B and Mo, and combinations thereof. By way of further example, in some embodiments the polyphosphate will contain at least 5 wt % (combined total) and up to about 25 wt % (combined total) of a metal selected from the group consisting of Zn, Fe, Mn, Cu, B and Mo, and combinations thereof. By way of further example, in some embodiments the polyphosphate will contain at least 5 wt % (combined total) and up to about 22 wt % (combined total) of a metal selected from the group consisting of Zn, Fe, Mn, Cu, B and Mo, and combinations thereof.

In one embodiment, the polyphosphate composition comprises at least 3 wt % zinc. For example, in some embodiments the polyphosphate comprises at least 5 wt % zinc. By way of further example, in some embodiments the polyphosphate comprises at least 8 wt % zinc. By way of further example, in some embodiments the polyphosphate comprises at least 10 wt % zinc. By way of further example, in some embodiments the polyphosphate comprises at least 15 wt % zinc.

In one embodiment, the polyphosphate composition comprises at least 1 wt % boron. For example, in some embodiments the polyphosphate comprises at least 1.5 wt % boron. By way of further example, in some embodiments the polyphosphate comprises at least 2 wt % boron.

In one embodiment, the polyphosphate composition comprises at least 3 wt % manganese. For example, in some embodiments the polyphosphate comprises at least 5 wt % manganese. By way of further example, in some embodiments the polyphosphate comprises at least 7 wt % manganese. By way of further example, in some embodiments the polyphosphate comprises at least 10 wt % manganese.

In one embodiment, the polyphosphate composition comprises at least 3 wt % copper. For example, in some embodiments the polyphosphate comprises at least 5 wt % copper. By way of further example, in some embodiments the polyphosphate comprises at least 7 wt % copper. By way of further example, in some embodiments the polyphosphate comprises at least 10 wt % copper.

In one embodiment, the polyphosphate composition comprises at least 1 wt % molybdenum. For example, in some embodiments the polyphosphate comprises at least 1.5 wt % molybdenum. By way of further example, in some embodiments the polyphosphate comprises at least 2 wt % molybdenum.

In one embodiment, the polyphosphate composition comprises at least 3 wt % iron. For example, in some embodiments the polyphosphate comprises at least 5 wt % iron. By way of further example, in some embodiments the polyphosphate comprises at least 7 wt % of iron. In general, in those embodiments in which the polyphosphate composition comprises iron, it is generally preferred that the polyphosphate composition: (i) comprise at least 0.5 wt % (total combined concentration) of zinc, boron, manganese, copper, molybdenum, or combinations thereof, (ii) comprise calcium as a basic cation (as described elsewhere herein), or (iii) contain less than 11 wt % iron. For example, in such embodiments the polyphosphate composition comprises at least about 3 wt % iron and at least 1 wt % (total combined concentration) of zinc, boron, manganese, copper, molybdenum, or combinations thereof. By way of further example, in some embodiments the polyphosphate comprises at least about 3 wt % iron and at least 2 wt % (total combined concentration) of zinc, boron, manganese, copper, molybdenum, or combinations thereof. By way of further example, in some embodiments the polyphosphate comprises at least about 3 wt % iron and at least 3 wt % (total combined concentration) of zinc, boron, manganese, copper, molybdenum, or combinations thereof. In another embodiment, the polyphosphate comprises at least about 3 wt % iron and at least 1 wt % calcium. By way of further example, in some embodiments the polyphosphate comprises at least about 3 wt % iron and at least 2 wt % calcium. By way of further example, in some embodiments the polyphosphate comprises at least about 3 wt % iron and at least 3 wt % calcium. By way of further example, in some embodiments the polyphosphate comprises at least about 5 wt % iron and at least 2 wt % calcium.

### Basic Cations

The solubility of the polyphosphate composition in water and Morgan's extractant is influenced, in part, by the concentration and selection of micronutrient metals incorporated into the polyphosphate composition. In general, zinc, iron, manganese, and copper when incorporated tend to decrease the solubility of the polyphosphate composition whereas boron and molybdenum tend to increase the solubility of the polyphosphate composition in water and Morgan's extractant when incorporated. Similarly, magnesium, potassium and ammonium when incorporated tend to increase and calcium when incorporated tends to decrease the solubility of the polyphosphate composition in water, and ammonium tends to decrease the solubility of the polyphosphate composition in Morgan's extractant. In accordance with one aspect of the present disclosure, therefore, the solubility of the polyphosphate composition in water and in Morgan's extractant may be tuned by the incorporation of a basic cation that compensates or offsets the impact upon such solubilities resulting from presence or absence of one or more micronutrient metals incorporated into the polyphosphate composition. For example, in certain embodiments the basic cations are selected from the group consisting of calcium, magnesium and combinations thereof, and optionally, additional cations may be selected from the group consisting of ammonium and potassium. By way of further example, in such embodiments, the polyphosphate composition contains at least 1 wt %, 3 wt %, at least 5 wt %, at least 7 wt % or even at least 8.5 wt % of calcium, magnesium or a combination thereof and, in addition, optionally ammonium or potassium cations. By way of further example, in one embodiment, the polyphosphate composition comprises at least 1 wt % calcium, at least 1 wt % magnesium, or at least 1 wt % of each of calcium and magnesium.

Water solubility of small chain polyphosphates containing only the basic cations, calcium, magnesium, potassium, and ammonium tend to be high. In order to reduce the solubility of such compounds in water, it has been observed that the incorporation of a small amount of micronutrient metal cation is advantageous. For example, a calcium polyphosphate with iron incorporated in the structure has reduced water solubility in water compared to one that has no iron in the structure.

In one embodiment, the polyphosphate composition contains less than 2 wt % micronutrient metal. To compensate for the absence of micronutrient metals, in this embodiment the polyphosphate composition preferably contains at least about 15 wt % basic cations selected from the group consisting of ammonium, calcium, magnesium, potassium, and combinations thereof. For example, in one such embodiment, the polyphosphate composition contains at least about 17 wt % basic cations selected from the group consisting of ammonium, calcium, magnesium, potassium, and combinations thereof. By way of further example, in one such embodiment the polyphosphate composition preferably contains at least about 20 wt % basic cations selected from the group consisting of ammonium, calcium, magnesium, potassium, and combinations thereof. By way of further example, in one such embodiment the polyphosphate composition preferably contains at least about 22 wt % basic cations selected from the group consisting of ammonium, calcium, magnesium, potassium, and combinations thereof. In certain embodiments, the basic cations are selected from the group consisting of calcium and magnesium and, in these embodiments, the polyphosphate contains at least 15 wt %, at least 17 wt %, at least 20 wt % or at least 22 wt % basic cations selected from the group consisting of calcium and magnesium. In general, however, the polyphosphate composition will typically comprise less than 30 wt % or even less than 25 wt % basic cations selected from the group consisting of ammonium, calcium, magnesium and potassium.

In other embodiments the polyphosphate composition contains at least 2 wt %, e.g., at least 6 wt % micronutrient metal. For example, in such embodiments the polyphosphate composition contains at least 7 wt % micronutrient metal. By way of further example in one such embodiment the polyphosphate composition contains at least 8 wt % micronutrient metal. By way of further example in one such embodiment the polyphosphate composition contains at least 9 wt % micronutrient metal. In these embodiments, the polyphosphate composition tends to include lesser amounts of basic cations. For example, in these embodiments the polyphosphate composition typically contains less than about 30 wt % basic cations selected from the group consisting of ammonium, calcium, magnesium, potassium, and combinations thereof. By way of further example in such embodiments the polyphosphate composition typically contains less than about 26 wt % basic cations selected from the group consisting of ammonium, calcium, magnesium, potassium, and combinations thereof. By way of further example in such embodiments the polyphosphate composition typically contains less than about 24 wt % basic cations selected from the group consisting of ammonium, calcium, magnesium, potassium, and combinations thereof. By way of further example in such embodiments the polyphosphate composition typically contains less than about 20 wt % basic cations selected from the group consisting of ammonium, calcium, magnesium, potassium, and combinations thereof. By way of further example in such embodiments the polyphosphate composition typically contains less than about 15 wt % basic cations selected from the group consisting of ammonium, calcium, magnesium, potassium, and combinations thereof. By way of further example in such embodiments the polyphosphate composition typically contains less than about 12 wt % basic cations selected from the group consisting of ammonium, calcium, magnesium, potassium, and combinations thereof. By way of further example in these embodiments the polyphosphate composition may contain less than 10 wt % basic cations selected from the group consisting of ammonium, calcium, magnesium, potassium, and combinations thereof. By way of further example in these embodiments the polyphosphate composition may contain less than 9 wt % basic cations selected from the group consisting of ammonium, calcium, magnesium, potassium, and combinations thereof. By way of further example in these embodiments the polyphosphate composition may contain less than 8 wt % basic cations selected from the group consisting of ammonium, calcium, magnesium, potassium, and combinations thereof. By way of further example in these embodiments the polyphosphate composition may contain less than 7 wt % basic cations selected from the group consisting of ammonium, calcium, magnesium, potassium, and combinations thereof. In each of the foregoing embodiments, the polyphosphate may comprise a basic cation selected from the group consisting of ammonium, calcium and magnesium, and combinations thereof. Alternatively, in each of the foregoing embodiments the polyphosphate may comprise a basic cation selected from the group consisting of ammonium and calcium, and combinations thereof. By way of further alternative, in each of the foregoing embodiments the polyphosphate may comprise a basic cation selected from the group consisting of ammonium and magnesium, and combinations thereof. By way of further alternative, in each of the foregoing embodiments the polyphosphate may comprise magnesium as the predominant basic cation. By way of further alternative, in each of the foregoing embodiments the polyphosphate may comprise calcium as the predominant basic cation.

In certain embodiments, the basic cations are selected from the group consisting of calcium and magnesium and, in these embodiments, the polyphosphate contains no more than 28 wt %, no more than 25 wt %, no more than 20 wt %, no more than 18 wt %, or no more than 15 wt %, basic cations selected from the group consisting of calcium and magnesium. In general, however, the polyphosphate composition will typically comprise at least 20 wt % or even more than 22 wt % basic cations selected from the group consisting of calcium and magnesium. By way of further example, in certain embodiments the polyphosphate composition contains 7 to 12 wt %, in others 8 to 10 wt % and in others even 25 to 30 wt % of the basic cations.

In certain embodiments, the basic cations are selected from the group consisting of calcium and magnesium and, additional cations are optionally selected from the group consisting of ammonium and potassium. In these embodiments, the polyphosphate contains no more than 28 wt %, no more than 25 wt %, no more than 20 wt %, no more than 18 wt %, or no more than 15 wt %, basic cations selected from the group consisting of calcium and magnesium. In general, however, the polyphosphate composition will typically comprise at least 20 wt % or even more than 22 wt % basic cations selected from the group consisting of calcium and magnesium. By way of further example, in certain embodiments the polyphosphate composition contains 7 to 12 wt %, in others 8 to 10 wt % and in others even 25 to 30 wt % of the basic cations calcium and/or magnesium.

In general, the combined amount of calcium and magnesium in the polyphosphate composition will range from about 15 wt % to about 30 wt % provided, however, the total magnesium content of the polyphosphate does not exceed 15 wt %. In an exemplary embodiment, the calcium content of the polyphosphate composition will range from about 15 wt % to about 30 wt %. In general, however, the polyphosphate composition will typically comprise relatively more calcium and/or magnesium than each of potassium or ammonium. For example, in one embodiment, the polyphosphate composition comprises no more than 10 wt % magnesium and typically no more than 7 wt % magnesium, 5 wt % magnesium, 2 wt % or even 1 wt % magnesium as determined in a total magnesium assay. Similarly, in one embodiment, the polyphosphate composition comprises no more than 5 wt % nitrogen and typically no more than 4 wt % nitrogen, 3 wt % nitrogen, 2 wt % or even 1 wt % nitrogen as determined in a total nitrogen assay. Similarly, in one embodiment, the polyphosphate composition comprises no more than 5 wt % potassium and typically no more than 4 wt % potassium, 3 wt % potassium, or even no more than 2 wt % potassium as determined in a total potassium assay.

### Orthophosphate Content

In general, the polyphosphate composition of the present disclosure contains orthophosphate with the orthophosphate content being at least about 30 wt %. For example, in one embodiment the orthophosphate content of the polyphosphate is at least about 33 wt %. By way of further example, in one embodiment the orthophosphate content of the polyphosphate is at least about 35 wt %. By way of further example, in one embodiment the orthophosphate content of the polyphosphate is at least about 37 wt %. By way of further example, in one embodiment the orthophosphate content of the polyphosphate is at least about 39 wt %. By way of further example in one embodiment the orthophosphate fraction of the polyphosphate is at least 40 wt %. By way of further example in one embodiment the orthophosphate fraction of the polyphosphate is at least 43 wt %. By way of further example in one embodiment the orthophosphate fraction of the polyphosphate is at least 45 wt %. In general, the orthophosphate fraction of the polyphosphate does not exceed 60 wt %. For example, in one embodiment the orthophosphate fraction of the polyphosphate does not exceed 59 wt %. By way of further example, in one embodiment the orthophosphate fraction of the polyphosphate does not exceed 58 wt %. By way of further example, in one embodiment the orthophosphate fraction of the polyphosphate does not exceed 57 wt %. By way of further example, in one embodiment the orthophosphate fraction of the polyphosphate does not exceed 56 wt %. In certain embodiments, the orthophosphate fraction of the polyphosphate will fall within the range of 30 to 60 wt %, 37 to 60 wt %, 40 to 60 wt %, 37 to 59 wt %, 37 to 58 wt % or 37 to 56 wt %, or 40 to 59 wt %.

### Chain Length

The polyphosphate composition of the present disclosure has a number average chain length including orthophosphate, of at least 1.1. For example, in one embodiment the polyphosphate has a number average chain length of at least 1.2. By way of further example, in one embodiment the polyphosphate composition has a number average chain length including orthophosphate of at least 1.25. By way of further example, in one embodiment the polyphosphate composition has a number average chain length including orthophosphate of at least 1.3. By way of further example, in one embodiment the polyphosphate composition has a number average chain length including orthophosphate of at least 1.35. By way of further example, in one embodiment the polyphosphate composition has a number average chain length including orthophosphate of at least 1.4.

By way of further example, in one embodiment the polyphosphate composition has a number average chain length including orthophosphate of at least 1.45. By way of further example, in one embodiment the polyphosphate composition has a number average chain length including orthophosphate of at least 1.5. By way of further example, in one embodiment the polyphosphate composition has a number average chain length including orthophosphate of at least 1.51. By way of further example, in one embodiment the polyphosphate composition has a number average chain length including orthophosphate of at least 1.52. By way of further example, in one embodiment the polyphosphate composition has a number average chain length including orthophosphate of at least 1.53. By way of further example, in one embodiment the polyphosphate composition has a number average chain length including orthophosphate of at least 1.55. In general, however, the polyphosphate composition will have a number average chain length including orthophosphate of no more than 3.5. By way of further example, in one embodiment the polyphosphate composition will have a number average chain length including orthophosphate of no more than 3.3. By way of further example, in one embodiment the polyphosphate composition will have a number average chain length including orthophosphate of no more than 3.2. By way of further example, in one embodiment the polyphosphate composition will have a number average chain length including orthophosphate of no more than 3.0. By way of further example, in one embodiment the polyphosphate composition will have a number average chain length including orthophosphate of no more than 2.5. Typically, the polyphosphate composition will have a number average chain length including orthophosphate in the range of 1.1 to 3.5. For example, in one embodiment the polyphosphate composition has a number average chain length including orthophosphate in the range of 1.2 to 2.8. By way of further example, in one embodiment the polyphosphate composition has a number average chain length including orthophosphate in the range of 1.3 to 2.8. By way of further example, in one embodiment the polyphosphate composition has a number average chain length including orthophosphate in the range of 1.4 to 2.5. By way of further example, in one embodiment the polyphosphate composition has a number average chain length including orthophosphate in the range of 1.55 to 2.5. By way of further example, in one embodiment the polyphosphate composition has a number average chain length including orthophosphate in the range of 1.55 to 2.3.

### Orthophosphate to Chain Length

Based upon experimental evidence to-date and without being limited to any particular theory, it appears that polyphosphate compositions having a ratio of orthophosphate content (wt %) to number average chain length (including orthophosphate) may be advantageous. For example, a ratio of the weight ratio of orthophosphate comprised by the polyphosphate to the number average chain length of the polyphosphate (including orthophosphate) within the range of 10:1 to 38:1, respectively, may be advantageous. In certain embodiments, for example, the ratio of the weight ratio of orthophosphate comprised by the polyphosphate to the number average chain length of the polyphosphate (including orthophosphate) may be within the range of 8:1 to 36:1, respectively. In certain embodiments, for example, the ratio of the weight ratio of orthophosphate comprised by the polyphosphate to the number average chain length of the polyphosphate (including orthophosphate) may be within the range of 15:1 to 36:1, respectively. In certain embodiments, for example, the ratio of the weight ratio of orthophosphate comprised by the polyphosphate to the number average chain length of the polyphosphate (including orthophosphate) may be within the range of 20:1 to 36:1, respectively. In certain embodiments, for example, the ratio of the weight ratio of orthophosphate comprised by the polyphosphate to the number average chain length of the polyphosphate (including orthophosphate) may be within the range of 20:1 to 38:1, respectively. In certain embodiments, for example, the ratio of the weight ratio of orthophosphate comprised by the polyphosphate to the number average chain length of the polyphosphate (including orthophosphate) may be within the range of 21:1 to 36:1, respectively.

Based upon experimental evidence to-date and without being limited to any particular theory, it appears that polyphosphate compositions having a range of orthophosphate contents (total phosphate as orthophosphate in the polyphosphate composition, expressed as wt %) and range of ratios of orthophosphate content to number average chain length (including orthophosphate) may be advantageous. For example, in one embodiment the polyphosphate composition has an orthophosphate content of 30 wt % to 60 wt % and a ratio of its orthophosphate content (expressed as wt %) to the number average chain length of the polyphosphate (including orthophosphate) within the range of 8:1 to 25:1, respectively. By way of further example in certain embodiments, the polyphosphate has an orthophosphate content of 33 wt % to 60 wt % and a ratio of its orthophosphate to number average chain length (including orthophosphate) is within the range of 9:1 to 28:1, respectively. By way of further example in certain embodiments, the polyphosphate has an orthophosphate content of 35 wt % to 60 wt % and a ratio of its orthophosphate to number average chain length (including orthophosphate) is within the range of 10:1 to 27:1, respectively. By way of further example in certain embodiments, the polyphosphate has an orthophosphate content of 37 wt % to 60 wt % and a ratio of its orthophosphate to number average chain length (including orthophosphate) is within the range of 10:1 to 29:1, respectively. By way of further example in certain embodiments, the polyphosphate has an orthophosphate content of 37 wt % to 60 wt % and a ratio of its orthophosphate to number average chain length (including orthophosphate) is within the range of 20:1 to 38:1, respectively. By way of further example in certain embodiments, the polyphosphate has an orthophosphate content of 37 wt % to 59 wt % and a ratio of its orthophosphate to number average chain length (including orthophosphate) is within the range of 20:1 to 40:1, respectively. By way of further example in certain embodiments, the polyphosphate has an orthophosphate content of 37 wt % to 58 wt % and a ratio of its orthophosphate to number average chain length (including orthophosphate) is within the range of 20:1 to 38:1, respectively. By way of further example in certain embodiments, the polyphosphate has an orthophosphate content of 40 wt % to 58 wt % and a ratio of its orthophosphate to number average chain length (including orthophosphate) is within the range of 20:1 to 38:1, respectively.

### Water Solubility

In general, the polyphosphate composition of the present disclosure that is soluble in a Water Solubility Assay is less than 35 wt % of the total amount of phosphorous in the polyphosphate composition. For example, in one such embodiment, the fraction of phosphorous in the polyphosphate composition soluble in Water Solubility Assay is less than 25 wt % of the total amount of phosphorous in the polyphosphate composition. By way of further example, in one such embodiment, the fraction of phosphorous in the polyphosphate composition soluble in Water Solubility Assay is less than 20 wt % of the total amount of phosphorous in the polyphosphate composition. By way of further example, in one such embodiment, the fraction of phosphorous in the polyphosphate composition soluble in Water Solubility Assay is less than 15 wt % of the total amount of phosphorous in the polyphosphate composition. By way of further example, in one such embodiment, the fraction of phosphorous in the polyphosphate composition soluble in Water Solubility Assay is less than 10 wt % of the total amount of phosphorous in the polyphosphate composition. By way of further example, in one such embodiment, the fraction of phosphorous in the polyphosphate composition soluble in Water Solubility Assay is less than 10 wt % of the total amount of phosphorous in the polyphosphate composition. By way of further example, in one such embodiment, the fraction of phosphorous in the polyphosphate composition soluble in Water Solubility Assay is less than 8 wt % of the total amount of phosphorous in the polyphosphate composition. By way of further example, in one such embodiment, the fraction of phosphorous in the polyphosphate composition soluble in Water Solubility Assay is less than 6 wt % of the total amount of phosphorous in the polyphosphate composition. By way of further example, in one such embodiment, the fraction of phosphorous in the polyphosphate composition soluble in Water Solubility Assay is less than 4 wt % of the total amount of phosphorous in the polyphosphate composition.

Typically, a portion of phosphorous in the polyphosphate composition of the present disclosure will be soluble in a Water Solubility Assay. For example, in one embodiment the fraction of phosphorous that is soluble in a Water Solubility Assay will be at least 0.5 wt % of the total amount of phosphorous in the polyphosphate composition. By way of further example, in one such embodiment, the fraction of phosphorous in the polyphosphate composition that is soluble in Water Solubility Assay is at least 1 wt % of the total amount of phosphorous in the polyphosphate composition. By way of further example, in one such embodiment, the fraction of phosphorous in the polyphosphate composition that is soluble in Water Solubility Assay is at least 5 wt % of the total amount of phosphorous in the polyphosphate composition.

In certain embodiments, the fraction of phosphorous in the polyphosphate composition that is soluble in Water Solubility Assay is in the range of 25% to 35 wt % of the total amount of phosphorous in the polyphosphate composition. In other embodiments, the fraction of phosphorous in the polyphosphate composition that is soluble in Water Solubility Assay is in the range of 6% to 12 wt % of the total amount of phosphorous in the polyphosphate composition. In other embodiments, the fraction of phosphorous in the polyphosphate composition that is soluble in Water Solubility Assay is in the range of 2% to 5 wt % of the total amount of phosphorous in the polyphosphate composition. In other embodiments, the fraction of phosphorous in the polyphosphate composition that is soluble in Water Solubility Assay is in the range of 0.5% to 2 wt % of the total amount of phosphorous in the polyphosphate composition. In other embodiments, the fraction of phosphorous in the polyphosphate composition that is soluble in Water Solubility Assay is in the range of 1% to 2.5 wt % of the total amount of phosphorous in the polyphosphate composition.

In certain embodiments, the fraction of micronutrient metals in the polyphosphate composition that is soluble in a Water Solubility Assay is less than 35 wt % of the total amount of micronutrient metals in the polyphosphate composition. By way of further example, in one embodiment the fraction of micronutrient metals in the polyphosphate composition that is soluble in a Water Solubility Assay is less than 32 wt % of the total amount of micronutrient metals in the polyphosphate composition. By way of further example, in one embodiment the fraction of micronutrient metals in the polyphosphate composition that is soluble in a Water Solubility Assay is less than 30 wt % of the total amount of micronutrient metals in the polyphosphate composition. By way of further example, in one embodiment the fraction of micronutrient metals in the polyphosphate composition that is soluble in a Water Solubility Assay is less than 28 wt % of the total amount of micronutrient metals in the polyphosphate composition. By way of further example, in one embodiment the fraction of micronutrient metals in the polyphosphate composition that is soluble in a Water Solubility Assay is less than 25 wt % of the total amount of micronutrient metals in the polyphosphate composition. By way of further example, in one embodiment the fraction of micronutrient metals in the polyphosphate composition that is soluble in a Water Solubility Assay is less than 22 wt % of the total amount of micronutrient metals in the polyphosphate composition. By way of further example, in one embodiment the fraction of micronutrient metals in the polyphosphate composition that is soluble in a Water Solubility Assay is less than 20 wt % of the total amount of micronutrient metals in the polyphosphate composition. By way of further example, in one embodiment the fraction of micronutrient metals in the polyphosphate composition that is soluble in a Water Solubility Assay is less than 18 wt % of the total amount of micronutrient metals in the polyphosphate composition. By way of further example, in one embodiment the fraction of micronutrient metals in the polyphosphate composition that is soluble in a Water Solubility Assay is less than 15 wt % of the total amount of micronutrient metals in the polyphosphate composition. By way of further example, in one embodiment the fraction of micronutrient metals in the polyphosphate composition that is soluble in a Water Solubility Assay is less than 13 wt % of the total amount of micronutrient metals in the polyphosphate composition. By way of further example, in one embodiment the fraction of micronutrient metals in the polyphosphate composition that is soluble in a Water Solubility Assay is less than 12 wt % of the total amount of micronutrient metals in the polyphosphate composition. By way of further example, in one embodiment the fraction of micronutrient metals in the polyphosphate composition that is soluble in a Water Solubility Assay is less than 11 wt % of the total amount of micronutrient metals in the polyphosphate composition. By way of further example, in one embodiment the fraction of micronutrient metals in the polyphosphate composition that is soluble in a Water Solubility Assay is less than 10 wt % of the total amount of micronutrient metals in the polyphosphate composition. By way of further example, in one embodiment the fraction of micronutrient metals in the polyphosphate composition that is soluble in a Water Solubility Assay is less than 9 wt % of the total amount of micronutrient metals in the polyphosphate composition. By way of further example, in one embodiment the fraction of micronutrient metals in the polyphosphate composition that is soluble in a Water Solubility Assay is less than 8 wt % of the total amount of micronutrient metals in the polyphosphate composition. By way of further example, in one embodiment the fraction of micronutrient metals in the polyphosphate composition that is soluble in a Water Solubility Assay is less than 7 wt % of the total amount of micronutrient metals in the polyphosphate composition. By way of further example, in one embodiment the fraction of micronutrient metals in the polyphosphate composition that is soluble in a Water Solubility Assay is less than 6 wt % of the total amount of micronutrient metals in the polyphosphate composition. By way of further example, in one embodiment the fraction of micronutrient metals in the polyphosphate composition that is soluble in a Water Solubility Assay is less than 5 wt % of the total amount of micronutrient metals in the polyphosphate composition. By way of further example, in one embodiment the fraction of micronutrient metals in the polyphosphate composition that is soluble in a Water Solubility Assay is less than 4 wt % of the total amount of micronutrient metals in the polyphosphate composition. By way of further example, in one embodiment the fraction of micronutrient metals in the polyphosphate composition that is soluble in a Water Solubility Assay is less than 3 wt % of the total amount of micronutrient metals in the polyphosphate composition. By way of further example, in one embodiment the fraction of micronutrient metals in the polyphosphate composition that is soluble in a Water Solubility Assay is less than 2 wt % of the total amount of micronutrient metals in the polyphosphate composition. By way of further example, in one embodiment the fraction of micronutrient metals in the polyphosphate composition that is soluble in a Water Solubility Assay is less than 1 wt % of the total amount of micronutrient metals in the polyphosphate composition. By way of further example, in one embodiment the fraction of micronutrient metals in the polyphosphate composition that is soluble in a Water Solubility Assay is less than 0.5 wt % of the total amount of micronutrient metals in the polyphosphate composition. By way of further example, in one embodiment the fraction of micronutrient metals in the polyphosphate composition that is soluble in a Water Solubility Assay is less than 0.1 wt % of the total amount of micronutrient metals in the polyphosphate composition. By way of further example, in one embodiment the fraction of micronutrient metals in the polyphosphate composition that is soluble in a Water Solubility Assay is less than 0.05 wt % of the total amount of micronutrient metals in the polyphosphate composition.

In certain embodiments, the fraction of micronutrient metals in the polyphosphate composition that is soluble in a Water Solubility Assay is at least 0.1 wt % of the total amount of micronutrient metals in the polyphosphate composition. By way of further example, in one embodiment the fraction of micronutrient metals in the polyphosphate composition that is soluble in a Water Solubility Assay is at least 0.2 wt % of the total amount of micronutrient metals in the polyphosphate composition. By way of further example, in one embodiment the fraction of micronutrient metals in the polyphosphate composition that is soluble in a Water Solubility Assay is at least 0.5 wt % of the total amount of micronutrient metals in the polyphosphate composition. By way of further example, in one embodiment the fraction of micronutrient metals in the polyphosphate composition that is soluble in a Water Solubility Assay is at least 1 wt % of the total amount of micronutrient metals in the polyphosphate composition. By way of further example, in one embodiment the fraction of micronutrient metals in the polyphosphate composition that is soluble in a Water Solubility Assay is at least 3 wt % of the total amount of micronutrient metals in the polyphosphate composition. By way of further example, in one embodiment the fraction of micronutrient metals in the polyphosphate composition that is soluble in a Water Solubility Assay is at least 5 wt % of the total amount of micronutrient metals in the polyphosphate composition. By way of further example, in one embodiment the fraction of micronutrient metals in the polyphosphate composition that is soluble in a Water Solubility Assay is at least 8 wt % of the total amount of micronutrient metals in the polyphosphate composition. By way of further example, in one embodiment the fraction of micronutrient metals in the polyphosphate composition that is soluble in a Water Solubility Assay is at least 10 wt % of the total amount of micronutrient metals in the polyphosphate composition. By way of further example, in one embodiment the fraction of micronutrient metals in the polyphosphate composition that is soluble in a Water Solubility Assay is at least 13 wt % of the total amount of micronutrient metals in the polyphosphate composition. By way of further example, in one embodiment the fraction of micronutrient metals in the polyphosphate composition that is soluble in a Water Solubility Assay is at least 15 wt % of the total amount of micronutrient metals in the polyphosphate composition. By way of further example, in one embodiment the fraction of micronutrient metals in the polyphosphate composition that is soluble in a Water Solubility Assay is at least 18 wt % of the total amount of micronutrient metals in the polyphosphate composition.

In certain embodiments, the fraction of micronutrient metals in the polyphosphate composition that is soluble in Water Solubility Assay is in the range of 0.05 wt % to 25 wt % of the total amount of micronutrient metals in the polyphosphate composition. For example, in certain embodiments, the fraction of micronutrient metals in the polyphosphate composition that is soluble in Water Solubility Assay is in the range of 0.1 wt % to 5 wt % of the total amount of the micronutrient metals in the polyphosphate composition. In other embodiments, the fraction of micronutrient metals in the polyphosphate composition that is soluble in Water Solubility Assay is in the range of 0.5 wt % to 1 wt % of the total amount of the micronutrient metals in the polyphosphate composition. In other embodiments, the fraction of micronutrient metals in the polyphosphate composition that is soluble in Water Solubility Assay is in the range of 0.5 wt % to 2 wt % of the total amount of the micronutrient metals in the polyphosphate composition. In other embodiments, the fraction of micronutrient metals in the polyphosphate composition that is soluble in Water Solubility Assay is in the range of 8 wt % to 15 wt % of the total amount of the micronutrient metals in the polyphosphate composition. In other embodiments, the fraction of micronutrient metals in the polyphosphate composition that is soluble in Water Solubility Assay is in the range of 9 wt % to 15 wt % of the total amount of the micronutrient metals in the polyphosphate composition. In other embodiments, the fraction of micronutrient metals in the polyphosphate composition that is soluble in Water Solubility Assay is in the range of 10 wt % to 15 wt % of the total amount of the micronutrient metals in the polyphosphate composition. In other embodiments, the fraction of micronutrient metals in the polyphosphate composition that is soluble in Water Solubility Assay is in the range of 20 wt % to 25 wt % of the total amount of the micronutrient metals in the polyphosphate composition. In other embodiments, the fraction of micronutrient metals in the polyphosphate composition that is soluble in Water Solubility Assay is in the range of 25 wt % to 35 wt % of the total amount of the micronutrient metals in the polyphosphate composition. In other embodiments, the fraction of micronutrient metals in the polyphosphate composition that is soluble in Water Solubility Assay is in the range of 0.5 wt % to 2 wt % of the total amount of the micronutrient metals in the polyphosphate composition. In each of the foregoing alternative embodiments, the water-soluble fraction of the polyphosphate may contain one or more of zinc, iron, manganese, copper, boron, and molybdenum.

### Morgan Extractant Solubility

In general, the polyphosphate compositions of the present disclosure have favorable solubility characteristics in Morgan extractant. For example, in one embodiment, the fraction of phosphorous in the polyphosphate composition that is soluble in a Morgan Assay is at least 48 wt % of the total amount of phosphorous in the polyphosphate composition. By way of further example, in one embodiment the fraction of phosphorous in the polyphosphate composition that is soluble in a Morgan Assay is at least 49.5 wt % of the total amount of phosphorous in the polyphosphate composition. By way of further example, in one embodiment the fraction of phosphorous in the polyphosphate composition that is soluble in a Morgan Assay is at least 50 wt % of the total amount of phosphorous in the polyphosphate composition. By way of further example, in one embodiment the fraction of phosphorous in the polyphosphate composition that is soluble in a Morgan Assay is at least 50.5 wt % of the total amount of phosphorous in the polyphosphate composition. By way of further example, in one embodiment the fraction of phosphorous in the polyphosphate composition that is soluble in a Morgan Assay is at least 51 wt % of the total amount of phosphorous in the polyphosphate composition. By way of further example, in one embodiment the fraction of phosphorous in the polyphosphate composition that is soluble in a Morgan Assay is at least 52 wt % of the total amount of phosphorous in the polyphosphate composition. By way of further example, in one embodiment the fraction of phosphorous in the polyphosphate composition that is soluble in a Morgan Assay is at least 53 wt % of the total amount of phosphorous in the polyphosphate composition. By way of further example, in one embodiment the fraction of phosphorous in the polyphosphate composition that is soluble in a Morgan Assay is at least 54 wt % of the total amount of phosphorous in the polyphosphate composition.

In general, the phosphorous in the polyphosphate composition that is soluble in a Morgan Assay is no more than 90 wt % of the total amount of phosphorous in the polyphosphate composition. For example, in one embodiment, the fraction of phosphorous in the polyphosphate composition that is soluble in a Morgan Assay is no more than 85 wt % of the total amount of phosphorous in the polyphosphate composition. By way of further example, in one embodiment, the fraction of phosphorous in the polyphosphate composition that is soluble in a Morgan Assay is no more than 80 wt % of the total amount of phosphorous in the polyphosphate composition. By way of further example, in one embodiment, the fraction of phosphorous in the polyphosphate composition that is soluble in a Morgan Assay is no more than 75 wt % of the total amount of phosphorous in the polyphosphate composition. By way of further example, in one embodiment, the fraction of phosphorous in the polyphosphate composition that is soluble in a Morgan Assay is no more than 70 wt % of the total amount of phosphorous in the polyphosphate composition. By way of further example, in one embodiment, the fraction of phosphorous in the polyphosphate composition that is soluble in a Morgan Assay is no more than 68 wt % of the total amount of phosphorous in the polyphosphate composition. By way of further example, in one embodiment, the fraction of phosphorous in the polyphosphate composition that is soluble in a Morgan Assay is no more than 65 wt % of the total amount of phosphorous in the polyphosphate composition. By way of further example, in one embodiment, the fraction of phosphorous in the polyphosphate composition that is soluble in a Morgan Assay is no more than 63 wt % of the total amount of phosphorous in the polyphosphate composition.

In a typical embodiment, the fraction of phosphorous in the polyphosphate composition that is soluble in a Morgan Assay is in the range of 50 wt % to 90 wt % of the total amount of phosphorous in the polyphosphate composition. For example, in one embodiment the fraction of phosphorous in the polyphosphate composition that is soluble in a Morgan Assay is in the range of 50.5 wt % to 65 wt % of the total amount of phosphorous in the polyphosphate composition. By way of further example, in one embodiment the fraction of phosphorous in the polyphosphate composition that is soluble in a Morgan Assay is in the range of 50 wt % to 65 wt % of the total amount of phosphorous in the polyphosphate composition. By way of further example, in one embodiment the fraction of phosphorous in the polyphosphate composition that is soluble in a Morgan Assay is in the range of 51 wt % to 67 wt % of the total amount of phosphorous in the polyphosphate composition.

### Bicarbonate Solubility

In certain embodiments, the fraction of phosphorous in the polyphosphate composition that is soluble in a Bicarbonate Assay is at least 48 wt % of the total amount of phosphorous in the polyphosphate composition. For example, in one embodiment the fraction of phosphorous in the polyphosphate composition that is soluble in a Bicarbonate Assay is at least 49 wt % of the total amount of phosphorous in the polyphosphate composition. By way of further example, in one embodiment the fraction of phosphorous in the polyphosphate composition that is soluble in a Bicarbonate Assay is at least 50 wt % of the total amount of phosphorous in the polyphosphate composition. By way of further example, in one embodiment the fraction of phosphorous in the polyphosphate composition that is soluble in a Bicarbonate Assay is at least 52 wt % of the total amount of phosphorous in the polyphosphate composition. Typically, the fraction of phosphorous in the polyphosphate composition that is soluble in a Bicarbonate Assay will not exceed 90 wt % of the total amount of phosphorous in the polyphosphate composition. For example, in one embodiment the fraction of phosphorous in the polyphosphate composition that is soluble in a Bicarbonate Assay will not exceed 80 wt % of the total amount of phosphorous in the polyphosphate composition. By way of further example, in one embodiment the fraction of phosphorous in the polyphosphate composition that is soluble in a Bicarbonate Assay is no more than 70 wt % of the total amount of phosphorous in the polyphosphate composition. By way of further example, in one embodiment the fraction of phosphorous in the polyphosphate composition that is soluble in a Bicarbonate Assay is no more than 65 wt % of the total amount of phosphorous in the polyphosphate composition. By way of further example, in one embodiment the fraction of phosphorous in the polyphosphate composition that is soluble in a Bicarbonate Assay is no more than 63 wt % of the total amount of phosphorous in the polyphosphate composition. In certain embodiments, the fraction of phosphorous in the polyphosphate composition that is soluble in a Bicarbonate Assay will be in the range of 49.5 wt % to 70 wt % of the total amount of phosphorous in the polyphosphate composition. For example, in certain embodiments the fraction of phosphorous in the polyphosphate composition that is soluble in a Bicarbonate Assay is in the range of 50 wt % to 65 wt % of the total amount of phosphorous in the polyphosphate composition. By way of further example, in certain embodiments the fraction of phosphorous in the polyphosphate composition that is soluble in a Bicarbonate Assay is in the range of 51 wt % to 65 wt % of the total amount of phosphorous in the polyphosphate composition.

### Citric Acid Solubility

In certain embodiments, the fraction of phosphorous in the polyphosphate composition that is soluble in a 2 wt % Citric Acid Assay is at least 85 wt % of the total amount of phosphorous in the polyphosphate composition. For example, in one embodiment the fraction of phosphorous in the polyphosphate composition that is soluble in a 2 wt % Citric Acid Assay is at least 90 wt % of the total amount of phosphorous in the polyphosphate composition. By way of further example, in one embodiment the fraction of phosphorous in the polyphosphate composition that is soluble in a 2 wt % Citric Acid Assay is at least 95 wt % of the total amount of phosphorous in the polyphosphate composition. Typically, the fraction of phosphorous in the polyphosphate composition that is soluble in a 2 wt % Citric Acid Assay is in the range of 85 wt % to 100 wt % of the total amount of phosphorous in the polyphosphate composition.

In certain embodiments, the fraction of micronutrient metals in the polyphosphate composition that is soluble in a Citric Acid Assay is at least 80 wt % of the total amount of micronutrient metals in the polyphosphate composition. For example, in one embodiment the fraction of micronutrient metals in the polyphosphate composition that is soluble in a Citric Acid Assay is at least 85 wt % of the total amount of micronutrient metals in the polyphosphate composition. By way of further example, in one embodiment the fraction of micronutrient metals in the polyphosphate composition that is soluble in a Citric Acid Assay is at least 90 wt % of the total amount of micronutrient metals in the polyphosphate composition. By way of further example, in one embodiment the fraction of micronutrient metals in the polyphosphate composition that is soluble in a Citric Acid Assay is at least 95 wt % of the total amount of micronutrient metals in the polyphosphate composition. By way of further example, in one embodiment the fraction of micronutrient metals in the polyphosphate composition that is soluble in a Citric Acid Assay is at least 99 wt % of the total amount of micronutrient metals in the polyphosphate composition. In certain embodiments the fraction of micronutrient metals in the polyphosphate composition that is soluble in a Citric Acid Assay is in the range of 95 wt % to 100 wt % of the total amount of micronutrient metals in the polyphosphate composition. In other embodiments, the fraction of micronutrient metals in the polyphosphate composition that is soluble in a Citric Acid Assay is in the range of 98 wt % to 100 wt % of the total amount of the micronutrient metals in the polyphosphate composition. In other embodiments, the fraction of micronutrient metals in the polyphosphate composition that is soluble in a Citric Acid Assay is in the range of 90 wt % to 99 wt % of the total amount of the micronutrient metals in the polyphosphate composition. In other embodiments, the fraction of micronutrient metals in the polyphosphate composition that is soluble in a Citric Acid Assay is in the range of 90 wt % to 100 wt % of the total amount of the micronutrient metals in the polyphosphate composition. In each of the foregoing alternative embodiments, the fraction of micronutrient metals that are soluble in a Citric Acid Assay may comprise one or more of zinc, iron, manganese, copper, boron, or molybdenum.

### Process of Preparation

In general, the method to produce polyphosphates of the given range of chain lengths requires heating orthophosphoric acid together with metal oxides or carbonates to allow a polycondensation reaction to occur. In accordance with the method of the present disclosure, the heating period is reduced to enable the formation of the polyphosphate with lower energy costs. The principle is that if the metal compound is added to acid at low temperature the total time and energy required to raise the temperature of the liquid to the polymerization temperature (e.g., 158° C.) will be much more than if the acid was at a higher temperature; this is because after addition of metal compound, the total bulk of the system increases and hence the energy required to increase the temperature of such a system is more than if the total bulk of the system was less. To illustrate, if amount of acid taken is A and amount of metal compound is B, then by adding B to A when the acid is at 30° C. we have a system that has A+B amount of material that has to be heated from 30° C. to 158° C. On the contrary, if the acid were preheated to say 143° C. and then we add the metal compound B, the initial heating up to 143° C. is only for A amount of material; only the subsequent heating from 143° C. to 158° C. is for A+B amount of material. Moreover, the exothermic heat of reaction when B is added to hot acid A also raises the temperature so that effectively the total heating required for A+B material is only for raising the temperature by a few degrees.

In one embodiment, the process for the preparation of a micronutrient metal containing polyphosphate compositions of the present disclosure comprises (i) combining a micronutrient compound with phosphoric acid at a temperature (Tp) between 25° C. and 155° C., to produce exothermic heat of reaction after the combination that contributes to increasing the temperature of the reaction mixture (Te), to within 15° C. of the polymerization temperature (Tf), i.e., Tf−Te<15° C., (ii) optionally, further heating to the polymerization temperature Tf, where Tf is between 80° C. and 165° C., (iii) wherein the Te and Tf temperatures are selected so that the polyphosphate product has a number average chain length between 1.2 and 2.5, solubility of P in a Bicarbonate Assay is more than 35% of total P and solubility of P in Morgan Assay is more than 34% of total P.

The process of the present disclosure includes the following enumerated embodiments.

Embodiment P1. A process for the preparation of a polyphosphate composition containing a micronutrient metal comprises (i) combining a micronutrient compound with phosphoric acid at a temperature (Tp) between 25° C. and 155° C., to produce exothermic heat of reaction after the combination that contributes to increasing the temperature of the reaction mixture (Te), to within 15° C. of the polymerization temperature (Tf), i.e., Tf−Te<15° C., (ii) optionally, further heating to the polymerization temperature Tf, where Tf is between 80° C. and 165° C., (iii) wherein the Te and Tf temperatures are selected so that the polyphosphate product has a number average chain length between 1.2 and 2.5, solubility of P in a Bicarbonate Assay is more than 35% of total P and solubility of P in Morgan Assay is more than 34% of total P.of any preceding enumerated embodiment wherein after polymerization reaction at Tf, water is added to the reaction mixture to maintain fluidity and arrest the polymerization.

Embodiment P2. A process for the preparation of a polyphosphate composition of Embodiment P1 wherein after polymerization reaction, the reaction mixture is neutralized with a basic compound.

Embodiment P3. A process for the preparation of a polyphosphate composition of any of Embodiments P1-P2 wherein after polymerization reaction, the reaction mixture is neutralized with a basic compound to a pH between 4 and 8.

Embodiment P4. A process for the preparation of a polyphosphate composition of any of Embodiments P1-P3 wherein after neutralization with a basic compound, the neutralized mixture is dried.

Embodiment P5. A process for the preparation of a polyphosphate composition of any of Embodiments P1-P4 wherein after neutralization with a basic compound, the neutralized mixture is dried to a temperature between 50° C. and 100° C.

Embodiment P6. A process for the preparation of a polyphosphate composition of any of Embodiments P1-P5 wherein after drying the neutralized mixture, the dried mass is ground to produce the polyphosphate product.

Embodiment P7. A process for the preparation of a polyphosphate composition of any of Embodiments P1-P6 wherein the phosphoric acid is orthophosphoric acid having any concentration between 45% and 62% P₂O₅.

Embodiment P8. A process for the preparation of a polyphosphate composition of any of Embodiments P1-P7 wherein the phosphoric acid is polyphosphoric acid obtained by adding water to P₂O₅.

Embodiment P9. A process for the preparation of a polyphosphate composition of any of Embodiments P1-P8 wherein the basic compound is oxide, hydroxide or carbonate of magnesium, calcium, potassium, and ammonium.

Embodiment P10. A process for the preparation of a polyphosphate composition of any of Embodiments P1-P9 wherein the acid temperature Tp, is between 25° C. and 45° C.

Embodiment P11. A process for the preparation of a polyphosphate composition of any of Embodiments P1-P10 wherein the acid temperature Tp, is between 50° C. and 70° C.

Embodiment P12. A process for the preparation of a polyphosphate composition of any of Embodiments P1-P11 wherein the acid temperature Tp is between 100° C. and 130° C.

Embodiment P13. A process for the preparation of a polyphosphate composition of any of Embodiments P1-P11 wherein the acid temperature Tp is between 130° C. and 150° C.

Embodiment P14. A process for the preparation of a polyphosphate composition of any of Embodiments P1-P13 wherein the acid temperature Tp, is between 140° C. and 150° C.

Embodiment P15. A process for the preparation of a polyphosphate composition of any of Embodiments P1-P14 wherein the acid temperature Tp, is between 143° C. and 155° C.

Embodiment P16. A process for the preparation of a polyphosphate composition of any of Embodiments P1-P15 wherein the exothermicity of the reaction between micronutrient compound and phosphoric acid is utilized to raise the temperature of the reactants to between 15° C. and 0° C. of the final polymerization temperature.

Embodiment P17. A process for the preparation of a polyphosphate composition of any of Embodiments P1-P16 wherein by utilizing the heat of reaction to raise the reactant temperature, heating period is reduced.

Embodiment P18. A process for the preparation of a polyphosphate composition of any of Embodiments P1-P17 wherein by preheating the acid to a temperature that will allow heat produced by the reaction of metal compound with phosphoric acid, to drive the temperature of the reactants close to the final polymerization temperature, the total heating period is reduced.

Embodiment P19. A process for the preparation of a polyphosphate composition of any of Embodiments P1-P18 wherein by utilizing the heat of reaction to raise the reactant temperature, heating period is reduced and energy savings result.

Embodiment P20. A process for the preparation of a polyphosphate composition of any of Embodiments P1-P19 wherein the Tf−Te, is less than 10° C.

Embodiment P21. A process for the preparation of a polyphosphate composition of any of Embodiments P1-P20 wherein the Tf−Te, is less than 5° C.

Embodiment P22. A process for the preparation of a polyphosphate composition of any of Embodiments P1-P21 wherein the Tf−Te, is less than 1° C.

Embodiment P23. A process for the preparation of a polyphosphate composition of any of Embodiments P1-P22 wherein the Tf−Te, is 0° C.

Embodiment P24. A process for the preparation of a polyphosphate composition of any of Embodiments P1-P23 wherein the Tf is between 145° C. and 170° C.

Embodiment P25. A process for the preparation of a polyphosphate composition of any of Embodiments P1-P24 wherein the Tf is between 150° C. and 165° C.

Embodiment P26. A process for the preparation of a polyphosphate composition of any of Embodiments P1-P25 wherein the Tf is between 153° C. and 165° C.

Embodiment P27. A process for the preparation of a polyphosphate composition of any of Embodiments P1-P26 wherein the Tf is between 100° C. and 125° C.

Embodiment P28. A process for the preparation of a polyphosphate composition of any of Embodiments P1-P27 wherein the Tf is between 80° C. and 100° C.

Embodiment P29. A process for the preparation of a polyphosphate composition of any of Embodiments P1-P28 wherein the neutralized product is dried at a temperature between 50° C. and 100° C.

Embodiment P30. A process for the preparation of a polyphosphate composition of any of Embodiments P1-P29 wherein the micronutrient is zinc and the compound is oxide, hydroxide or carbonate of zinc.

Embodiment P31. A process for the preparation of a polyphosphate composition of any of Embodiments P1-P30 wherein the micronutrient is iron and the compound is oxide, hydroxide or carbonate of iron.

Embodiment P32. A process for the preparation of a polyphosphate composition of any of Embodiments P1-P31 wherein the micronutrient is manganese and the compound is oxide, hydroxide or carbonate of manganese.

Embodiment P33. A process for the preparation of a polyphosphate composition of any of Embodiments P1-P32 wherein the micronutrient is copper and the compound is oxide, hydroxide or carbonate of copper.

Embodiment P34. A process for the preparation of a polyphosphate composition of any of Embodiments P1-P33 wherein the micronutrient is boron and the compound is boric acid or borax.

Embodiment P35. A process for the preparation of a polyphosphate composition of any of Embodiments P1-P34 wherein the micronutrient is molybdenum and the compound is molybdenum trioxide.

Embodiment P36. A process for the preparation of a polyphosphate composition of any of Embodiments P1-P35 wherein the process comprises combining a zinc compound with phosphoric acid at a temperature (Tp) between 130° C. and 150° C. to produce exothermic heat of reaction after the combination that contributes to increasing the temperature of the reaction mixture (Te), to between 145° C. and 165° C. and then optionally further heating to the polymerization temperature between 150° C. and 165° C. to produce a polyphosphate product that has number average chain length between 1.2 and 2.5, solubility of P in a Bicarbonate Assay is more than 49.5% of total P and solubility of P in Morgan Assay is more than 51% of total P.

Embodiment P37. A process for the preparation of a polyphosphate composition of any of Embodiments P1-P36 wherein the exothermicity of the reaction between zinc oxide and phosphoric acid is utilized to raise the temperature of the reactants to within 10° C. of the final polymerization temperature.

Embodiment P38. A process for the preparation of a polyphosphate composition of any of Embodiments P1-P37 wherein the exothermicity of the reaction between zinc oxide and phosphoric acid is utilized to raise the temperature of the reactants to within 5° C. of the final polymerization temperature.

Embodiment P39. A process for the preparation of a polyphosphate composition of any of Embodiments P1-P38 wherein the exothermicity of the reaction between zinc oxide and phosphoric acid is utilized to raise the temperature of the reactants to within 2° C. of the final polymerization temperature.

Embodiment P40. A process for the preparation of a polyphosphate composition of any of Embodiments P1-P39 wherein the micronutrient is zinc and the final polymerization temperature is determined by the product having soluble P in Morgan Assay over 51% of total phosphorous.

Embodiment P41. A process for the preparation of a polyphosphate composition of any of Embodiments P1-P40 wherein after heating to the polymerization temperature, water is added to the zinc polyphosphate reaction mixture, to maintain its fluidity and arrest further polymerization.

Embodiment P42. A process for the preparation of a polyphosphate composition of any of Embodiments P1-P41 wherein the zinc polyphosphate reaction mixture is neutralized with a basic compound.

Embodiment P43. A process for the preparation of a polyphosphate composition of any of Embodiments P1-P42 wherein the zinc polyphosphate reaction mixture is neutralized with a basic compound that is magnesium oxide.

Embodiment P44. A process for the preparation of a polyphosphate composition of any of Embodiments P1-P43 wherein the zinc polyphosphate reaction mixture is neutralized with a basic compound that is magnesite.

Embodiment P45. A process for the preparation of a polyphosphate composition of any of Embodiments P1-P44 wherein the zinc polyphosphate reaction mixture is neutralized with a basic compound that is a mixture of magnesium oxide and calcium carbonate.

Embodiment P46. A process for the preparation of a polyphosphate composition of any of Embodiments P1-P45 wherein the process comprises combining a iron compound with phosphoric acid at a temperature (Tp) between 20° C. and 50° C. to produce exothermic heat of reaction after the combination that contributes to increasing the temperature of the reaction mixture (Te), to between 75° C. and 90° C. and then optionally further heating to the polymerization temperature between 80° C. and 95° C. to produce a polyphosphate product that has number average chain length between 1.2 and 2.1, solubility of P in a Bicarbonate Assay more than 49% of total P and solubility of P in Morgan Assay is more than 47.5% of total P.

Embodiment P47. A process for the preparation of a polyphosphate composition of any of Embodiments P1-P46 wherein the iron compound is magnetite (Fe₃O₄).

Embodiment P48. A process for the preparation of a polyphosphate composition of any of Embodiments P1-P47 wherein the iron compound, magnetite (Fe₃O₄), is added to the phosphoric acid as a slurry in water.

Embodiment P49. A process for the preparation of a polyphosphate composition of any of Embodiments P1-P48 wherein when magnetite (Fe₃O₄), is added to the phosphoric acid, the reaction vessel is water cooled to control the temperature rise.

Embodiment P50. A process for the preparation of a polyphosphate composition of any of Embodiments P1-P49 wherein the temperature difference Tf−Te is between 3° C. and 0° C.

Embodiment P51. A process for the preparation of a polyphosphate composition of any of Embodiments P1-P50 wherein the process comprises combining a magnetite slurry and a calcium compound with phosphoric acid at a temperature (Tp) between 145° C. and 155° C. to produce exothermic heat of reaction after the combination that contributes to increasing the temperature of the reaction mixture (Te), to between 150° C. and 160° C. and then optionally further heating to the polymerization temperature between 150° C. and 165° C. to produce a polyphosphate product that has number average chain length between 1.2 and 2.3, solubility of P in a Bicarbonate Assay more than 49.5% of total P and solubility of P in Morgan Assay is more than 51% of total P.

Embodiment P52. A process for the preparation of a polyphosphate composition of any of Embodiments P1-P51 wherein the process comprises combining a magnetite slurry and a calcium compound consisting of calcium oxide, with phosphoric acid preheated to a temperature between 145° C. and 155° C.

Embodiment P53. A process for the preparation of a polyphosphate composition of any of Embodiments P1-P52 wherein the reactants from combining a magnetite slurry and a calcium compound with phosphoric acid attain a temperature (Te) between 153° C. and 160° C.

Embodiment P54. A process for the preparation of a polyphosphate composition of any of Embodiments P1-P53 wherein after combining a magnetite slurry and a calcium compound with preheated phosphoric acid, the reactants are optionally further heated to a polymerization temperature between 153° C. and 160° C. to produce a calcium polyphosphate suspension.

Embodiment P55. A process for the preparation of a polyphosphate composition of any of Embodiments P1-P54 wherein the calcium polyphosphate suspension is combined with water to maintain fluidity.

Embodiment P56. A process for the preparation of a polyphosphate composition of any of Embodiments P1-P55 wherein the calcium polyphosphate with added water is neutralized with a suspension of calcium carbonate.

Embodiment P57. A process for the preparation of a polyphosphate composition of any of Embodiments P1-P56 wherein the neutralized calcium polyphosphate is dried at temperatures between 70° C. and 100° C.

Embodiment P58. A process for the preparation of a polyphosphate composition of any of Embodiments P1-P57 wherein the process comprises combining a manganese compound with phosphoric acid at a temperature (Tp) between 55° C. and 80° C. to produce exothermic heat of reaction after the combination that contributes to increasing the temperature of the reaction mixture (Te), to between 90° C. and 105° C. and then optionally further heating to the polymerization temperature between 85° C. and 100° C. to produce a manganese polyphosphate product that has number average chain length between 1.2 and 2, solubility of P in a Bicarbonate Assay is more than 49.5% of total P and solubility of P in Morgan Assay is more than 51% of total P.

Embodiment P59. A process for the preparation of a polyphosphate composition of any of Embodiments P1-P58 wherein the manganese compound is manganous oxide.

Embodiment P60. A process for the preparation of a polyphosphate composition of any of Embodiments P1-P59 wherein the manganese compound is a slurry of manganous oxide in water.

Embodiment P61. A process for the preparation of a polyphosphate composition of any of Embodiments P1-P60 wherein after adding manganous oxide slurry to preheated phosphoric acid, the exothermicity of the reaction drives the temperature of the reactants (Te) to between 85° C. and 100° C.

Embodiment P62. A process for the preparation of a polyphosphate composition of any of Embodiments P1-P61 wherein after mixing manganous oxide with preheated phosphoric acid, the mixture is combined with water.

Embodiment P63. A process for the preparation of a polyphosphate composition of any of Embodiments P1-P62 wherein the reaction mixture from manganous oxide and phosphoric acid is neutralized with a basic cation.

Embodiment P64. A polyphosphate composition prepared by the process of any of Embodiments P1-P63 wherein the polyphosphate reaction product after addition to neutralizing base, stirring, drying, and powdering is used to fertilize crops.

Embodiment P65. A process for the use of a polyphosphate composition prepared in accordance with the process of any of Embodiments P1-P64 wherein the product is used as powders, granulated, coated on other granular fertilizer fertilizers, or used as suspensions.

### Utilizations of Polyphosphate Compositions

The polyphosphate compositions of the present invention may contain, as a component thereof, a micronutrient metal polyphosphate composition, the micronutrient metal being one or more of the primary micronutrients described herein. Such fertilizer compositions may optionally contain other components that contribute to the nutritional, material handling, or other characteristics of the polyphosphate. For example, the polyphosphate composition may contain a water-soluble N—P—K macronutrient fertilizer composition that has been blended or otherwise combined with the micronutrient metal polyphosphate composition. By way of further example, the polyphosphate may contain micronutrient compositions other than the micronutrient metal polyphosphate that have been blended or otherwise combined with the micronutrient metal polyphosphate composition. By way of further example, the polyphosphate may contain organic materials like plant residues that have been blended or otherwise combined with the micronutrient metal polyphosphate composition to improve the material handling characteristics of the polyphosphate.

In one embodiment, a polyphosphate composition of the present disclosure may be incorporated into a composite particle having a size greater than 0.2 mm, the particle comprising a polyphosphate composition in solid form (optionally including one or more micronutrient metals) and a nitrogen source. For example, in addition to the polyphosphate composition described herein, the composite particles may comprise a nitrogen-source, a phosphorous source, a potassium-source, a secondary or micronutrient source. Exemplary nitrogen sources include urea, ammonium sulfate and derivatives thereof. Exemplary phosphorus sources include single superphosphates, triple superphosphates, calcium phosphates, nitrophosphates, potassium phosphates, ammonium phosphates, ammoniated superphosphates and the like and mixtures thereof. Exemplary potassium sources include muriate of potash, potassium sulfates, potassium phosphates, potassium hydroxides, potassium nitrates, potassium carbonates and bicarbonates, potassium magnesium sulfates and the like and mixtures thereof. Suitable secondary nutrient sources for use herein include elemental sulfur, calcium, and magnesium salts such as phosphates, oxides, sulfates, carbonates, chlorides, nitrates and the like and mixtures thereof. Suitable micronutrient sources include iron, manganese, copper, boron, zinc, and molybdenum salts such as phosphates, oxides, sulfates, carbonates, chlorides, nitrates, borates, molybdates and the like and mixtures thereof as well as chelates of micronutrients such as EDTA chelates and the like. For example, the following representative materials may be used as micronutrient sources in the present invention: calcium nitrate, magnesium sulfate, magnesium nitrate, ferrous sulfate, ferrous nitrate, manganese sulfate, manganese nitrate, copper sulfate, copper nitrate, boric acid, sodium borate, zinc sulfate, zinc nitrate, sodium molybdate, ammonium molybdate and the like. For example, in such embodiments, the composite particles may also comprise in addition to the nitrogen, phosphorous, potassium, secondary or micronutrient source about 0.01 wt. % to about 75 wt. % of a polyphosphate composition. By way of further example, in such embodiments, the composite particles may also comprise in addition to the nitrogen, phosphorous, potassium, secondary or micronutrient source about 0.01 wt. % to about 50 wt. % of a polyphosphate composition. By way of further example, in such embodiments, the composite particles may also comprise in addition to the nitrogen, phosphorous, potassium, secondary or micronutrient source about 0.01 wt. % to about 25 wt. % of a polyphosphate composition. By way of further example, in such embodiments, the composite particles may also comprise in addition to the nitrogen, phosphorous, potassium, secondary or micronutrient source about 0.1 wt. % to about 25 wt. % of a polyphosphate composition. By way of further example, in such embodiments, the composite particles may also comprise in addition to the nitrogen, phosphorous, potassium, secondary or micronutrient source about 0.5 wt. % to about 25 wt. % of a polyphosphate composition. By way of further example, in such embodiments, the composite particles may also comprise in addition to the nitrogen, phosphorous, potassium, secondary or micronutrient source about 0.5 wt. % to about 10 wt. % of a polyphosphate composition.

In another embodiment, the composite particles comprise a pesticide. The pesticide may be, for example, an herbicide, insecticide, fungicide, or combination thereof. Non-limiting examples of pesticides include 2-4D, parathion, malation, and s-triazines. For example, in such embodiments, the composite particles may also comprise in addition to the pesticide about 0.01 wt. % to about 75 wt. % of a polyphosphate composition described herein. By way of further example, in such embodiments, the composite particles may also comprise in addition to the pesticide about 0.01 wt. % to about 50 wt. % of a polyphosphate composition. By way of further example, in such embodiments, the composite particles may also comprise in addition to the pesticide about 0.01 wt. % to about 25 wt. % of a polyphosphate composition. By way of further example, in such embodiments, the composite particles may also comprise in addition to the pesticide about 0.1 wt. % to about 25 wt. % of a polyphosphate composition. By way of further example, in such embodiments, the composite particles may also comprise in addition to the pesticide about 0.5 wt. % to about 25 wt. % of a polyphosphate composition. By way of further example, in such embodiments, the composite particles may also comprise in addition to the pesticide about 0.5 wt. % to about 10 wt. % of a polyphosphate composition.

In one embodiment, the composite particles contain agrichemicals such as manure, gypsum, dolomite, and plant growth hormones. For example, in such embodiments, the composite particles may also comprise in addition to the agrichemicals about 0.01 wt. % to about 95 wt. % of a polyphosphate composition described herein. By way of further example, in such embodiments, the composite particles may also comprise in addition to the agrichemicals about 20 wt. % to about 95 wt. % of a polyphosphate composition. By way of further example, in such embodiments, the composite particles may also comprise in addition to the agrichemicals about 40 wt. % to about 95 wt. % of a polyphosphate composition. By way of further example, in such embodiments, the composite particles may also comprise in addition to the agrichemicals about 50 wt. % to about 95 wt. % of a polyphosphate composition. By way of further example, in such embodiments, the composite particles may also comprise in addition to the agrichemicals about 60 wt. % to about 95 wt. % of a polyphosphate composition. By way of further example, in such embodiments, the composite particles may also comprise in addition to the agrichemicals about 70 wt. % to about 95 wt. % of a polyphosphate composition.

In one embodiment, the composite particles contain granules of a macronutrient fertilizer, granules of china clay, bentonite, attapulgite, organic wastes, agricultural wastes having a size greater than 0.5 mm. In one embodiment, such particles have a size greater than 1 mm. In another embodiment, such particles have a size greater than 2 mm. In another embodiment, such particles have a size greater than 3 mm. Additionally, in such embodiments, the composite particles may also comprise about 10 wt. % to about 95 wt. % of a polyphosphate composition described herein. By way of further example, in such embodiments, the composite particles may also comprise about 30 wt. % to about 95 wt. % of a polyphosphate composition. By way of further example, in such embodiments, the composite particles may also comprise about 40 wt. % to about 95 wt. % of a polyphosphate composition. By way of further example, in such embodiments, the composite particles may also comprise about 50 wt. % to about 95 wt. % of a polyphosphate composition. By way of further example, in such embodiments, the composite particles may also comprise about 60 wt. % to about 95 wt. % of a polyphosphate composition. By way of further example, in such embodiments, the composite particles may also comprise about 70 wt. % to about 95 wt. % of a polyphosphate composition.

In one embodiment, the composite particles comprise plant seeds. For example, the composite particles may comprise soybean, corn, rice, or wheat seeds. Alternatively, the composite particles may comprise seeds of a plant other than soybean, corn, rice and wheat. Regardless of the type of seed, in such embodiments, the composite particles may also comprise in addition to one or more seeds about 0.01 wt. % to about 75 wt. % of a polyphosphate composition described herein. By way of further example, in such embodiments, the composite particles may also comprise in addition to one or more seeds about 0.01 wt. % to about 50 wt. % of a polyphosphate composition. By way of further example, in such embodiments, the composite particles may also comprise in addition to one or more seeds about 0.01 wt. % to about 25 wt. % of a polyphosphate composition. By way of further example, in such embodiments, the composite particles may also comprise in addition to one or more seeds about 0.1 wt. % to about 25 wt. % of a polyphosphate composition. By way of further example, in such embodiments, the composite particles may also comprise in addition to one or more seeds about 0.5 wt. % to about 25 wt. % of a polyphosphate composition. By way of further example, in such embodiments, the composite particles may also comprise in addition to one or more seeds about 0.5 wt. % to about 10 wt. % of a polyphosphate composition.

The present disclosure further includes the following enumerated embodiments.

Embodiment 1. Polyphosphate compositions comprising a basic cation selected from the group consisting of Ca, Mg, K and NH₄⁺ and optionally one or more micronutrients selected from the group consisting of Zn, Fe, Mn, Cu, B and Mo.

Embodiment 2. The polyphosphate composition of any previous enumerated embodiment wherein the polyphosphate composition has a number average chain length including orthophosphate of at least 1.5.

Embodiment 2.1. The polyphosphate composition of any previous enumerated embodiment wherein the polyphosphate composition has a number average chain length including orthophosphate of at least 1.51.

Embodiment 2.2. The polyphosphate composition of any previous enumerated embodiment wherein the polyphosphate composition has a number average chain length including orthophosphate of at least 1.52.

Embodiment 2.3. The polyphosphate composition of any previous enumerated embodiment wherein the polyphosphate composition has a number average chain length including orthophosphate of at least 1.53.

Embodiment 3. The polyphosphate composition of any previous enumerated embodiment wherein the polyphosphate composition has a number average chain length including orthophosphate of at least 1.55.

Embodiment 4. The polyphosphate composition of any previous enumerated embodiment wherein the polyphosphate composition has a number average chain length including orthophosphate of at least 1.6.

Embodiment 5. The polyphosphate composition of any previous enumerated embodiment wherein the polyphosphate composition has a number average chain length including orthophosphate of no more than 2.2.

Embodiment 6. The polyphosphate composition of any previous enumerated embodiment wherein the polyphosphate composition has a number average chain length including orthophosphate of no more than 2.0.

Embodiment 7. The polyphosphate composition of any previous enumerated embodiment wherein the polyphosphate composition has a number average chain length including orthophosphate of no more than 1.9.

Embodiment 8. The polyphosphate composition of any previous enumerated embodiment wherein the polyphosphate has a number average chain length including orthophosphate in the range of 1.5 to 2.0.

Embodiment 9. The polyphosphate composition of any previous enumerated embodiment wherein the polyphosphate composition contains at least 30 wt % orthophosphate.

Embodiment 10. The polyphosphate composition of any previous enumerated embodiment wherein the polyphosphate composition contains at least 40 wt % orthophosphate.

Embodiment 11. The polyphosphate composition of any previous enumerated embodiment wherein the polyphosphate composition contains at least 45 wt % orthophosphate.

Embodiment 12. The polyphosphate composition of any previous enumerated embodiment wherein the polyphosphate composition contains at least 50 wt % orthophosphate.

Embodiment 13. The polyphosphate composition of any previous enumerated embodiment wherein the polyphosphate composition contains no more than 65 wt % orthophosphate.

Embodiment 14. The polyphosphate composition of any previous enumerated embodiment wherein the polyphosphate composition contains 40 wt % to 60 wt % orthophosphate.

Embodiment 15. The polyphosphate composition of any previous enumerated embodiment wherein the polyphosphate composition contains 45 wt % to 55 wt % orthophosphate.

Embodiment 16. The polyphosphate composition of any previous embodiment where the polyphosphate composition contains at least 3 wt % of the basic cation.

Embodiment 17. The polyphosphate composition of any previous embodiment where the polyphosphate composition contains at least 5 wt % of the basic cation.

Embodiment 18. The polyphosphate composition of any previous embodiment where the polyphosphate composition contains at least 7 wt % of the basic cation.

Embodiment 19. The polyphosphate composition of any previous embodiment where the polyphosphate composition contains at least 8.5 wt % of the basic cation.

Embodiment 20. The polyphosphate composition of any previous enumerated embodiment wherein the polyphosphate composition no more than 35 wt % of the basic cation.

Embodiment 21. The polyphosphate composition of any previous enumerated embodiment wherein the polyphosphate composition no more than 30 wt % of the basic cation.

Embodiment 22. The polyphosphate composition of any previous enumerated embodiment wherein the polyphosphate composition no more than 24 wt % of the basic cation.

Embodiment 23. The polyphosphate composition of any previous enumerated embodiment wherein the polyphosphate composition no more than 20 wt % of the basic cation.

Embodiment 24. The polyphosphate composition of any previous enumerated embodiment wherein the polyphosphate composition no more than 15 wt % of the basic cation.

Embodiment 25. The polyphosphate composition of any previous enumerated embodiment where in the basic cation comprises calcium.

Embodiment 26. The polyphosphate composition of any previous enumerated embodiment where in the basic cation comprises magnesium.

Embodiment 27. The polyphosphate composition of any previous enumerated embodiment where in the basic cation comprises ammonium.

Embodiment 28. The polyphosphate composition of any previous enumerated embodiment where in the basic cation comprises potassium.

Embodiment 29. The polyphosphate composition of any previous enumerated embodiment where in the basic cation comprises calcium and magnesium.

Embodiment 30. The polyphosphate composition of any previous embodiment where the polyphosphate composition contains no more than 35 wt % of micronutrient(s).

Embodiment 31. The polyphosphate composition of any previous embodiment where the polyphosphate composition contains no more than 30 wt % of micronutrient(s).

Embodiment 32. The polyphosphate composition of any previous embodiment where the polyphosphate composition contains no more than 25 wt % of micronutrient(s).

Embodiment 33. The polyphosphate composition of any previous embodiment where the polyphosphate composition contains no more than 15 wt % of micronutrient(s).

Embodiment 34. The polyphosphate composition of any previous embodiment where the polyphosphate composition contains no more than 10 wt % of micronutrient(s).

Embodiment 35. The polyphosphate composition of any previous embodiment where the polyphosphate composition contains no more than 5 wt % of micronutrient(s).

Embodiment 36. The polyphosphate composition of any previous embodiment where the polyphosphate composition contains no more than 1 wt % of micronutrient(s).

Embodiment 37. The polyphosphate composition of any previous embodiment where the polyphosphate composition contains no more than 0.5 wt % of micronutrient(s).

Embodiment 38. The polyphosphate composition of any previous embodiment where the polyphosphate composition contains no less than 0.1 wt % of micronutrient(s).

Embodiment 39. The polyphosphate composition of any previous embodiment where the polyphosphate composition contains no less than 0.5 wt % of micronutrient(s).

Embodiment 40. The polyphosphate composition of any previous embodiment where the polyphosphate composition contains no less than 1 wt % of micronutrient(s).

Embodiment 41. The polyphosphate composition of any previous embodiment where the polyphosphate composition contains no less than 2 wt % of micronutrient(s).

Embodiment 42. The polyphosphate composition of any previous embodiment where the polyphosphate composition contains no less than 5 wt % of micronutrient(s).

Embodiment 43. The polyphosphate composition of any previous embodiment where the polyphosphate composition contains no less than 10 wt % of micronutrient(s).

Embodiment 44. The polyphosphate composition of any previous embodiment where the micronutrient in the polyphosphate composition is Zn.

Embodiment 45. The polyphosphate composition of any previous embodiment where the micronutrient in the polyphosphate composition is Fe.

Embodiment 46. The polyphosphate composition of any previous embodiment where the micronutrient in the polyphosphate composition is Mn.

Embodiment 47. The polyphosphate composition of any previous embodiment where the micronutrient in the polyphosphate composition is Cu.

Embodiment 48. The polyphosphate composition of any previous embodiment where the micronutrient in the polyphosphate composition is B.

Embodiment 49. The polyphosphate composition of any previous embodiment where the micronutrient in the polyphosphate composition is Mo.

Embodiment 50. The polyphosphate composition of any preceding enumerated embodiment wherein the fraction of phosphorous in the polyphosphate composition soluble in water solubility assay is less than 35 wt % of the total amount of phosphorous in the polyphosphate composition.

Embodiment 51. The polyphosphate composition of any preceding enumerated embodiment wherein the fraction of phosphorous in the polyphosphate composition soluble in water solubility assay is less than 30 wt % of the total amount of phosphorous in the polyphosphate composition.

Embodiment 52. The polyphosphate composition of any preceding enumerated embodiment wherein the fraction of phosphorous in the polyphosphate composition soluble in water solubility assay is less than 25 wt % of the total amount of phosphorous in the polyphosphate composition.

Embodiment 53. The polyphosphate composition of any preceding enumerated embodiment wherein the fraction of phosphorous in the polyphosphate composition soluble in water solubility assay is less than 20 wt % of the total amount of phosphorous in the polyphosphate composition.

Embodiment 54. The polyphosphate composition of any preceding enumerated embodiment wherein the fraction of phosphorous in the polyphosphate composition soluble in water solubility assay is less than 15 wt % of the total amount of phosphorous in the polyphosphate composition.

Embodiment 55. The polyphosphate composition of any preceding enumerated embodiment wherein the fraction of phosphorous in the polyphosphate composition soluble in water solubility assay is less than 10 wt % of the total amount of phosphorous in the polyphosphate composition.

Embodiment 56. The polyphosphate composition of any preceding enumerated embodiment wherein the fraction of phosphorous in the polyphosphate composition soluble in water solubility assay is less than 5 wt % of the total amount of phosphorous in the polyphosphate composition.

Embodiment 57. The polyphosphate composition of any preceding enumerated embodiment wherein the fraction of phosphorous in the polyphosphate composition soluble in water solubility assay is less than 1 wt % of the total amount of phosphorous in the polyphosphate composition.

Embodiment 58. The polyphosphate composition of any preceding enumerated embodiment wherein the fraction of phosphorous in the polyphosphate composition soluble in water solubility assay is at least 1 wt % of the total amount of phosphorous in the polyphosphate composition.

Embodiment 59. The polyphosphate composition of any preceding enumerated embodiment wherein the fraction of phosphorous in the polyphosphate composition soluble in water solubility assay is at least 5 wt % of the total amount of phosphorous in the polyphosphate composition.

Embodiment 60. The polyphosphate composition of any preceding enumerated embodiment wherein the fraction of phosphorous in the polyphosphate composition soluble in water solubility assay is at least 10 wt % of the total amount of phosphorous in the polyphosphate composition.

Embodiment 61. The polyphosphate composition of any preceding enumerated embodiment wherein the fraction of phosphorous in the polyphosphate composition that is soluble in a Morgan assay is at least 34 wt % of the total amount of phosphorous in the polyphosphate composition.

Embodiment 62. The polyphosphate composition of any preceding enumerated embodiment wherein the fraction of phosphorous in the polyphosphate composition that is soluble in a Morgan assay is at least 40 wt % of the total amount of phosphorous in the polyphosphate composition.

Embodiment 63. The polyphosphate composition of any preceding enumerated embodiment wherein the fraction of phosphorous in the polyphosphate composition that is soluble in a Morgan assay is at least 45 wt % of the total amount of phosphorous in the polyphosphate composition.

Embodiment 64. The polyphosphate composition of any preceding enumerated embodiment wherein the fraction of phosphorous in the polyphosphate composition that is soluble in a Morgan assay is at least 48.5 wt % of the total amount of phosphorous in the polyphosphate composition.

Embodiment 65. The polyphosphate composition of any preceding enumerated embodiment wherein the fraction of phosphorous in the polyphosphate composition that is soluble in a Morgan assay is at least 50 wt % of the total amount of phosphorous in the polyphosphate composition.

Embodiment 66. The polyphosphate composition of any preceding enumerated embodiment wherein the fraction of phosphorous in the polyphosphate composition that is soluble in a Morgan assay is at least 51 wt % of the total amount of phosphorous in the polyphosphate composition.

Embodiment 67. The polyphosphate composition of any preceding enumerated embodiment wherein the fraction of phosphorous in the polyphosphate composition that is soluble in a Morgan assay is at least 52 wt % of the total amount of phosphorous in the polyphosphate composition.

Embodiment 68. The polyphosphate composition of any preceding enumerated embodiment wherein the fraction of phosphorous in the polyphosphate composition that is soluble in a Morgan assay is no more than 90 wt % of the total amount of phosphorous in the polyphosphate composition.

Embodiment 69. The polyphosphate composition of any preceding enumerated embodiment wherein the fraction of phosphorous in the polyphosphate composition that is soluble in a Morgan assay is no more than 75 wt % of the total amount of phosphorous in the polyphosphate composition.

Embodiment 70. The polyphosphate composition of any preceding enumerated embodiment wherein the fraction of phosphorous in the polyphosphate composition that is soluble in a Morgan assay is no more than 65 wt % of the total amount of phosphorous in the polyphosphate composition.

Embodiment 71. The polyphosphate composition of any preceding enumerated embodiment wherein the fraction of phosphorous in the polyphosphate composition that is soluble in a Morgan assay is no more than 61 wt % of the total amount of phosphorous in the polyphosphate composition.

Embodiment 72. The polyphosphate composition of any preceding enumerated embodiment wherein the fraction of phosphorous in the polyphosphate composition that is soluble in 0.1N bicarbonate assay is at least 47 wt % of the total amount of phosphorous in the polyphosphate composition.

Embodiment 73. The polyphosphate composition of any preceding enumerated embodiment wherein the fraction of phosphorous in the polyphosphate composition that is soluble in 0.1N bicarbonate assay is at least 50 wt % of the total amount of phosphorous in the polyphosphate composition.

Embodiment 74. The polyphosphate composition of any preceding enumerated embodiment wherein the fraction of phosphorous in the polyphosphate composition that is soluble in 0.1N bicarbonate assay is at least 52 wt % of the total amount of phosphorous in the polyphosphate composition.

Embodiment 75. The polyphosphate composition of any preceding enumerated embodiment wherein the fraction of phosphorous in the polyphosphate composition that is soluble in a 0.1N bicarbonate assay is no more than 90 wt % of the total amount of phosphorous in the polyphosphate composition.

Embodiment 76. The polyphosphate composition of any preceding enumerated embodiment wherein the fraction of phosphorous in the polyphosphate composition that is soluble in a 0.1N bicarbonate assay is no more than 75 wt % of the total amount of phosphorous in the polyphosphate composition.

Embodiment 77. The polyphosphate composition of any preceding enumerated embodiment wherein the fraction of phosphorous in the polyphosphate composition that is soluble in a 0.1N bicarbonate assay is no more than 65 wt % of the total amount of phosphorous in the polyphosphate composition.

Embodiment 78. The polyphosphate composition of any preceding enumerated embodiment wherein the fraction of phosphorous in the polyphosphate composition that is soluble in a 0.1N bicarbonate assay is in the range of 48 wt % to 65 wt % of the total amount of phosphorous in the polyphosphate composition.

Embodiment 79. The polyphosphate composition of any preceding enumerated embodiment wherein the fraction of phosphorous in the polyphosphate composition that is soluble in a 2 wt % Citric Acid Assay is at least 70 wt % of the total amount of phosphorous in the polyphosphate composition.

Embodiment 80. The polyphosphate composition of any preceding enumerated embodiment wherein the fraction of phosphorous in the polyphosphate composition that is soluble in a 2 wt % Citric Acid Assay is at least 80 wt % of the total amount of phosphorous in the polyphosphate composition.

Embodiment 81. The polyphosphate composition of any preceding enumerated embodiment wherein the fraction of phosphorous in the polyphosphate composition that is soluble in a 2 wt % Citric Acid Assay is at least 90 wt % of the total amount of phosphorous in the polyphosphate composition.

Embodiment 82. The polyphosphate composition of any preceding enumerated embodiment wherein the water-soluble fraction of the micronutrient(s) is less than 35 wt % of the total amount of the micronutrient(s) in the polyphosphate composition.

Embodiment 83. The polyphosphate composition of any preceding enumerated embodiment wherein the water-soluble fraction of the micronutrient(s) is less than 30 wt % of the total amount of the micronutrient(s) in the polyphosphate composition.

Embodiment 84. The polyphosphate composition of any preceding enumerated embodiment wherein the water-soluble fraction of the micronutrient(s) is less than 25 wt % of the total amount of the micronutrient(s) in the polyphosphate composition.

Embodiment 85. The polyphosphate composition of any preceding enumerated embodiment wherein the water-soluble fraction of the micronutrient(s) is less than 20 wt % of the total amount of the micronutrient(s) in the polyphosphate composition.

Embodiment 86. The polyphosphate composition of any preceding enumerated embodiment wherein the water-soluble fraction of the micronutrient(s) is less than 15 wt % of the total amount of the micronutrient(s) in the polyphosphate composition.

Embodiment 87. The polyphosphate composition of any preceding enumerated embodiment wherein the water-soluble fraction of the micronutrient(s) is less than 10 wt % of the total amount of the micronutrient(s) in the polyphosphate composition.

Embodiment 88. The polyphosphate composition of any preceding enumerated embodiment wherein the water-soluble fraction of the micronutrient(s) is less than 5 wt % of the total amount of the micronutrient(s) in the polyphosphate composition.

Embodiment 89. The polyphosphate composition of any preceding enumerated embodiment wherein the water-soluble fraction of micronutrient metal(s) in the polyphosphate composition is less than 1 wt % of the total amount of the micronutrient(s) in the polyphosphate composition.

Embodiment 90. The polyphosphate composition of any preceding enumerated embodiment wherein the water-soluble fraction of the micronutrient(s) in the polyphosphate composition is at least 0.1 wt % of the total amount of the micronutrient(s) in the polyphosphate composition.

Embodiment 91. The polyphosphate composition of any preceding enumerated embodiment wherein the water-soluble fraction of the micronutrient(s) in the polyphosphate composition is at least 0.5 wt % of the total amount of the micronutrient(s) in the polyphosphate composition.

Embodiment 92. The polyphosphate composition of any preceding enumerated embodiment wherein the water-soluble fraction of the micronutrient(s) in the polyphosphate composition is at least 1 wt % of the total amount of the micronutrient(s) in the polyphosphate composition.

Embodiment 93. The polyphosphate composition of any preceding enumerated embodiment wherein the water-soluble fraction of the micronutrient(s) in the polyphosphate composition is at least 5 wt % of the total amount of the micronutrient(s) in the polyphosphate composition.

Embodiment 94. The polyphosphate composition of any preceding enumerated embodiment wherein the water-soluble fraction of the micronutrient(s) in the polyphosphate composition is in the range of 0.5 wt % to 2 wt % of the total amount of the micronutrient(s) in the polyphosphate composition.

Embodiment 95. The polyphosphate composition of any preceding enumerated embodiment wherein the water-soluble fraction of the micronutrient(s) in the polyphosphate composition is in the range of 8 wt % to 15 wt % of the total amount of the micronutrient(s) in the polyphosphate composition.

Embodiment 96. The polyphosphate composition of any preceding enumerated embodiment wherein the water-soluble fraction of the micronutrient(s) in the polyphosphate composition is in the range of 25 wt % to 35 wt % of the total amount of the micronutrient(s) in the polyphosphate composition.

Embodiment 97. The polyphosphate composition of any preceding enumerated embodiment wherein the water-soluble fraction of the micronutrient(s) in the polyphosphate composition is in the range of 10 wt % to 15 wt % of the total amount of the micronutrient(s) in the polyphosphate composition.

Embodiment 98. The polyphosphate composition of any preceding enumerated embodiment wherein the water-soluble fraction of the polyphosphate composition comprises Zn.

Embodiment 99. The polyphosphate composition of any preceding enumerated embodiment wherein the water-soluble fraction of the polyphosphate composition comprises Fe.

Embodiment 100. The polyphosphate composition of any preceding enumerated embodiment wherein the water-soluble fraction of the polyphosphate composition comprises Mn.

Embodiment 101. The polyphosphate composition of any preceding enumerated embodiment wherein the water-soluble fraction of the polyphosphate composition comprises Cu.

Embodiment 102. The polyphosphate composition of any preceding enumerated embodiment wherein the water-soluble fraction of the polyphosphate composition comprises B.

Embodiment 103. The polyphosphate composition of any preceding enumerated embodiment wherein the water-soluble fraction of the polyphosphate composition comprises Mo.

Embodiment 104. The polyphosphate composition of any preceding enumerated embodiment wherein the fraction of the micronutrient(s) soluble in Morgan assay is at least 30 wt % of the total amount of the micronutrient(s) in the polyphosphate composition.

Embodiment 105. The polyphosphate composition of any preceding enumerated embodiment wherein the fraction of the micronutrient(s) soluble in Morgan assay is at least 34 wt % of the total amount of the micronutrient(s) in the polyphosphate composition.

Embodiment 106. The polyphosphate composition of any preceding enumerated embodiment wherein the fraction of the micronutrient(s) soluble in Morgan assay is at least 40 wt % of the total amount of the micronutrient(s) in the polyphosphate composition.

Embodiment 107. The polyphosphate composition of any preceding enumerated embodiment wherein the fraction of the micronutrient(s) soluble in Morgan assay is at least 45 wt % of the total amount of the micronutrient(s) in the polyphosphate composition.

Embodiment 108. The polyphosphate composition of any preceding enumerated embodiment wherein the fraction of the micronutrient(s) soluble in Morgan assay is at least 50 wt % of the total amount of the micronutrient(s) in the polyphosphate composition.

Embodiment 109. The polyphosphate composition of any preceding enumerated embodiment wherein the fraction of the micronutrient(s) soluble in Morgan assay is at least 55 wt % of the total amount of the micronutrient(s) in the polyphosphate composition.

Embodiment 110. The polyphosphate composition of any preceding enumerated embodiment wherein the fraction of the micronutrient(s) soluble in Morgan assay is at least 60 wt % of the total amount of the micronutrient(s) in the polyphosphate composition.

Embodiment 111. The polyphosphate composition of any preceding enumerated embodiment wherein the fraction of the micronutrient(s) soluble in Morgan assay is at least 66 wt % of the total amount of the micronutrient(s) in the polyphosphate composition.

Embodiment 112. The polyphosphate composition of any preceding enumerated embodiment wherein the fraction of the micronutrient(s) soluble in Morgan assay is at least 70 wt % of the total amount of the micronutrient(s) in the polyphosphate composition.

Embodiment 113. The polyphosphate composition of any preceding enumerated embodiment wherein the Morgan assay soluble fraction of the polyphosphate composition comprises Zn.

Embodiment 114. The polyphosphate composition of any preceding enumerated embodiment wherein the Morgan assay soluble fraction of the polyphosphate composition comprises Fe.

Embodiment 115. The polyphosphate composition of any preceding enumerated embodiment wherein the Morgan assay soluble fraction of the polyphosphate composition comprises Mn.

Embodiment 116. The polyphosphate composition of any preceding enumerated embodiment wherein the Morgan assay soluble fraction of the polyphosphate composition comprises Cu.

Embodiment 117. The polyphosphate composition of any preceding enumerated embodiment wherein the Morgan assay soluble fraction of the polyphosphate composition comprises B.

Embodiment 118. The polyphosphate composition of any preceding enumerated embodiment wherein the Morgan assay soluble fraction of the polyphosphate composition comprises Mo.

Embodiment 119. The polyphosphate composition of any preceding enumerated embodiment wherein the fraction of micronutrient(s) in the polyphosphate composition that is soluble in a 2 wt % Citric Acid Assay is at least 70 wt % of the total amount of micronutrient(s) in the polyphosphate composition.

Embodiment 120. The polyphosphate composition of any preceding enumerated embodiment wherein the fraction of micronutrient(s) in the polyphosphate composition that is soluble in a 2 wt % Citric Acid Assay is at least 90 wt % of the total amount of micronutrient(s) in the polyphosphate composition.

Embodiment 121. The polyphosphate composition of any preceding enumerated embodiment wherein the water solubility assay for P comprises by weighing 500 mg of product (passed through a 180-micron sieve), into an Erlenmeyer flask adding 50 mL double distilled water at 30° C. to it, shaking on a horizontal shaker for 30 min, filtering, washing, making to volume, digesting an aliquot with 5 mL HCl to its boiling point over a hotplate for 15 min and analyzing P in the extract spectrophotometrically as the molybdovanadophosphate ((AOAC 1990, assay no. 958.01).

Embodiment 122. The polyphosphate composition of any preceding enumerated embodiment wherein the water solubility assay for micronutrients comprises weighing 500 mg of product (passed through a 180-micron sieve), into an Erlenmeyer flask adding 50 mL double distilled water at 30° C. to it, shaking on a horizontal shaker for 30 min, filtering, washing, adding 2 mL concentrated HCl, making up to volume and analyzing the Zn, Cu and Mo content by AAS (atomic absorption spectroscopy) (AOAC 1990), Fe content colorimetrically as the red o-phenanthroline complex (Mendham et al., 2006), Mn colorimetrically as the permanganate after oxidation with KIO₃ (Maxwell 1968), B as the 1,1′-dianthrimide in concentrated sulfuric acid (Jeffrey et al. 1989).

Embodiment 123. The polyphosphate composition of any preceding enumerated embodiment wherein the assay for total P comprises weighing 100 mg of product (passed through a 180-micron sieve) into an Erlenmeyer flask, adding 10 mL concentrated HCl to it, digesting over a hot plate for 15 min, cooling, making up to volume and analyzing P as molybdovanadophosphate (AOAC 1990, assay no. 958.01).

Embodiment 124. The polyphosphate composition of any preceding enumerated embodiment wherein the assay for total Zn, Fe, Mn, Cu, Ca, Mg and K is obtained by weighing 100 mg of product (passed through a 180-micron sieve) into an Erlenmeyer flask, adding 10 mL concentrated HCl to it, digesting over a hot plate for 15 min, cooling, making up to volume and analyzing micronutrients as described above in connection with the Water Solubility Assay for micronutrient metals.

Embodiment 125. The polyphosphate composition of any preceding enumerated embodiment wherein the assay for total N is obtained by Kjeldahl's method (AOAC 1990, assay no. 978.02) using product passed through a 180-micron sieve.

Embodiment 126. The polyphosphate composition of any preceding enumerated embodiment wherein the Morgan solubility assay comprises weighing 100 mg of product (passed through a 180 micron sieve) into an Erlenmeyer flask, adding 50 mL of Morgan's extractant consisting of a solution of 0.72 N NaOAc+0.52 N CH₃COOH at pH 4.8 (Lunt et al. 1958) at 30 C, shaking in a horizontal shaker for 15 min, filtering, washing making up to volume, taking an aliquot in a volumetric flask, adding 10 mL concentrated HCl to it, digesting over a hot plate for 15 min, cooling, making up to volume and analyzing P as molybdovanadophosphate (AOAC 1990, assay no. 958.01).

Embodiment 127. The polyphosphate composition of any preceding enumerated embodiment wherein the 0.1N bicarbonate solubility assay comprises weighing 100 mg of product (passed through a 180-micron sieve) into an Erlenmeyer flask, adding 50 mL 0.1N NaHCO₃ at 30 C to it, shaking the suspension for 60 min on a horizontal shaker, filtering, washing, making up to volume, taking an aliquot in a volumetric flask, adding mL concentrated HCl to it, digesting over a hot plate for 15 min, cooling, making up to volume and analyzing P as molybdovanadophosphate (AOAC 1990, assay no. 958.01).

Embodiment 128. The polyphosphate composition of any preceding enumerated embodiment wherein the 2 wt % citric acid solubility assay comprises weighing 50 mg fertilizer (passed through a 180-micron sieve) into a stoppered 250 mL Erlenmeyer flask, adding 50 mL of 2% citric acid it, placing the suspension in a horizontal shaker for 15 min, filtering, washing and making up to volume in a volumetric flask and analyzing for Zn by AAS (AOAC 1990, assay no. 965.09).

Embodiment 129. As used herein, the assay for the chain length and orthophosphate content comprises taking 30 g of a strong acid cation exchange resin (Amberlite IR 120) in an Erlenmeyer flask, converting it to a H-form by treatment with 80 mL of 0.1 N HCl, shaking it for 15 min in a horizontal shaker, washing it free of Cl⁻ with repeated washing for 25 times with 20 mL portions of double distilled water, adding 1 g product (passed through a 180-micron sieve) to the resin suspension, placing on a shaker for 5 min, decanting through a Whatman 1 filter paper placed over a 100 mL volumetric flask, making up to volume, then (a) immediately pipetting 10 mL of the solution into a 50-mL beaker and adding 10 mL water, stirring the solution and immediately titrating he solution in a pH-meter with slow, dropwise addition of 0.1N NaOH as described by Van Wazer et al. (1954, 1966) to a pH of 10 (titration 1) so that the end point is detected within ±1 drop of NaOH, followed by (b) lowering the pH of the same solution to pH around 3 by addition of 0.1N HNO₃, adding 2 mL of freshly prepared 0.1N AgNO₃ solution and titrating again to an end point at around pH 7-8 (titration 2), and finally (c) taking another 5 mL aliquot of the same solution in a Ni crucible, adding 2 beads of NaOH (300 mg) to it, drying it slowly (for 90 min) over a hotplate (to avoid boiling and solution loss), finally heating the contents till NaOH has melted (fused), cooling the crucible and its contents to RT, adding 5 mL water to dissolve the contents, quantitatively transferring the contents to a solution of 1.5 mL concentrated HCl in 10 mL water, transferring this solution quantitatively into a 100 mL volumetric flask, making up to volume and determining total P by the same pH-metric titration process (titration 3) to an end point around pH 5-6, where the meq of NaOH (normality of NaOH×volume of NaOH) required for the titrations 1-3 is determined from (a) the amount of NaOH required to titrate from the first endpoint around pH 4.5 to the second endpoint near pH 9 for titration-1 is say T1, and this value is the amount of end group P (EP), (b) the amount of NaOH required to titrate the solution after addition of AgNO₃ to the endpoint near pH 6 for titration-2 is say T2, and amount of orthophosphate (OP) is obtained from the value of T2 minus the base consumed in T1, i.e., orthophosphate P, OP=(T2-T1) meq (c) the amount of NaOH required to titrate from the first endpoint around pH 4.5 to the second endpoint near pH 8-9 for titration-3 is say T3, and total P (TP) is obtained as 2×T3, and the value of average number of P atoms per chain (ñ) is evaluated as ñ=[{2(total P−orthophosphate P)}]/(end group P−orthophosphate P)}] or ñ=[{2(TP−OP)}]/(EP−OP)], where this value of ñ excludes the orthophosphate and if the ortho group is to be included in the value, then ñ′ (including ortho)=[ñ/{o (ñ−1)+1}] (Van Wazer, 1954, 1966), where OP=mole fraction of total P as orthophosphate.

An illustrative example of the three titrations is shown in FIG. 4. Titration 2 with silver nitrate is strongly influenced by the formation of Ag⁺ ions in AgNO₃ solution that has aged and will give serious error. The titration 2 is to be performed slowly to allow for neutralization of H⁺ ions adsorbed on the surface of silver phosphate precipitate; pH readings must be checked to verify that this equilibrium has attained. Titration 1 must be performed with sufficient concentration of P in the solution and in the amounts and dilutions described here. Excess dilution of the sample will give poor pH change and erroneous data.

Having described the invention in detail, it will be apparent that modifications and variations are possible without departing the scope of the invention defined in the appended claims. The following non-limiting examples are provided to further illustrate the present invention and those of skill in the art should, in light of the present disclosure, appreciate that many changes can be made in the specific embodiments that are disclosed and still obtain a like or similar result without departing from the spirit and scope of the invention.

### Examples

### Example 1: Zinc Polyphosphate

The fertilizer of this example was produced using zinc oxide and orthophosphoric acid (58% P₂O₅). In a 2 L beaker phosphoric acid (504 g) was taken. This was placed in an oil bath (initial temperature at 160° C.) and heated to 143° C. (Tp). Then 204 g of ZnO (79.8% Zn) was added to it with stirring. The molar ratio of Zn:P in this process was 1:1.65. The reaction was exothermic, and the temperature of the liquid rose to 151° C. (Te). Heating was continued till the liquid temperature reached 158° C. (Tf). Total time required was 50 min. The beaker was removed from the oil bath. 200 mL water was added to the reacted liquid (zinc polyphosphate) and stirred. Addition of water prevents the liquid become too viscous and solidifying, that would make material transfer very difficult. In a 5 L beaker, 280 mL water was taken, and 150 g magnesite (51% Mg) was added to it and stirred. The zinc polyphosphate reaction mixture was poured into the magnesite suspension with stirring. There was much frothing, and the reaction was exothermic. The product soon solidified. It was taken in steel trays and heated in an oven at 80° C. The dried product was ground to pass through 180-micron sieve.

The product contained 20.5% Zn, 15.6% P and 9.3% Mg. The number average chain length of the polyphosphate including orthophosphate (ñ′) was 1.6, number average chain length of the polyphosphate excluding orthophosphate (ñ) was 6.92, and the orthophosphate (OP) content was 56 wt % (Table 1). In a Water Solubility Assay, 6.9% of total P and 0.3% of total Zn was dissolved. In 0.1N NaHCO₃(Bicarbonate Assay), 57.45% of total P was dissolved and in Morgan's extractant (Morgan Assay) 59.56% of total P was dissolved and 73.03% of total Zn was dissolved (Table 1).

### Example 2: Zinc Polyphosphate

The fertilizer of this example was produced by adding ZnO to phosphoric acid at room temperature (25° C.). This example was only for the purpose of comparing heating periods when the acid is not pre-heated before addition of ZnO. In a 2 L beaker phosphoric acid (504 g of 58% P₂O₅) was taken. Then 204 g of ZnO (79.8% Zn) was added to it with stirring. Here Tp was 28° C. The reaction was exothermic and the temperature of the liquid rose to 110° C. (Te). Heating was continued till the liquid temperature reached 158° C. (Tf). The beaker was removed from the oil bath. Total time required was 85 min. The product was neutralized and processed as described in Example 1. The pH of the dried product was 5.97. The purpose of this reaction was to compare reaction periods when ZnO was added at much lower Tp compared to Example 1 and then to compare the properties of the product. This process required 20 min more of heating time compared to process in Example 1.

The product contained 21.7% Zn, 15.8% P and 9.5% Mg. The number average chain length of the polyphosphate including orthophosphate (ñ′) was 1.72, number average chain length of the polyphosphate excluding orthophosphate (ñ) was 9.33, and the orthophosphate (OP) content was 53.3 wt % (Table 1). In a Water Solubility Assay, 0.1% of total Zn was dissolved. In 0.1N NaHCO₃(Bicarbonate Assay), 52.82% of total P was dissolved and in Morgan's extractant (Morgan Assay) 54.02% of total P was dissolved and 61.23% of total Zn was dissolved. This example in comparison with Example 1 shows that when the acid is not preheated, the solubility of the product in NaHCO₃(Morgan Assay) and Morgan's extractant (Morgan Assay) is significantly reduced.

### Example 3: Zinc Polyphosphate

The fertilizer of this example was produced at higher final temperatures of 165° C. instead of 158° C. (as in Example 1). In a 2 L beaker phosphoric acid (504 g, 58% P₂O₅) was taken. This was placed in an oil bath (initially at 160° C.) and heated to a Tp of 153° C. (instead of 143° C. as in Example 1). The time to heat to 153° C. was 35 min. Then 204 g of ZnO (79.8% Zn) was added to it with stirring. The reaction was exothermic and the temperature of the liquid rose to 162° C. (Te). Heating was continued till the liquid temperature reached 165° C. (Tf). Total time required was 65 min. The beaker was removed from the oil bath. The product was neutralized and processed as described in Example 1.

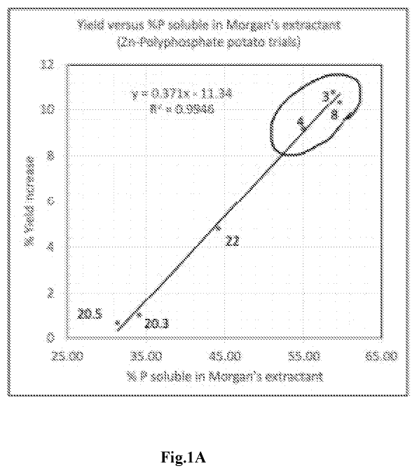

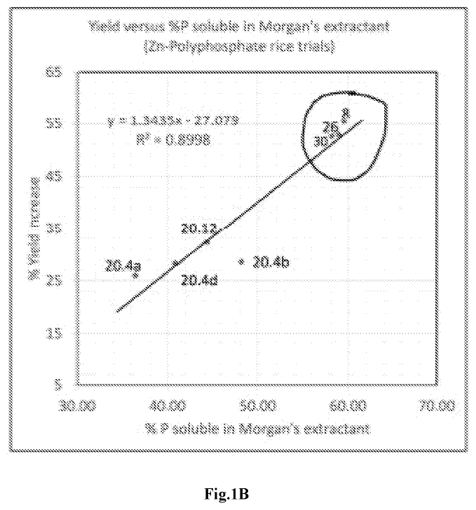

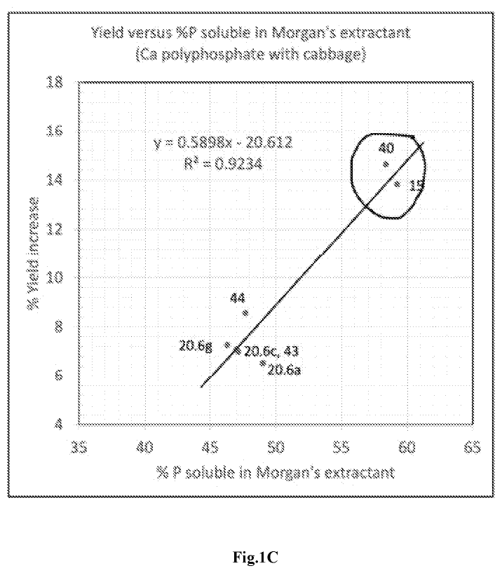

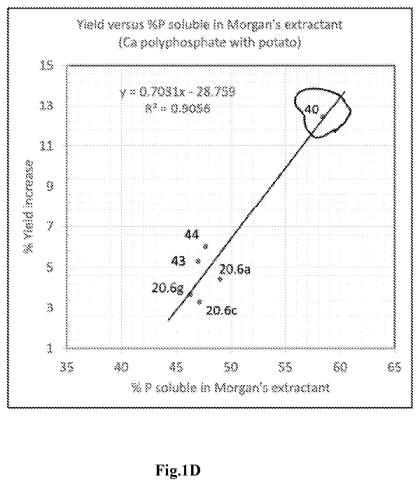

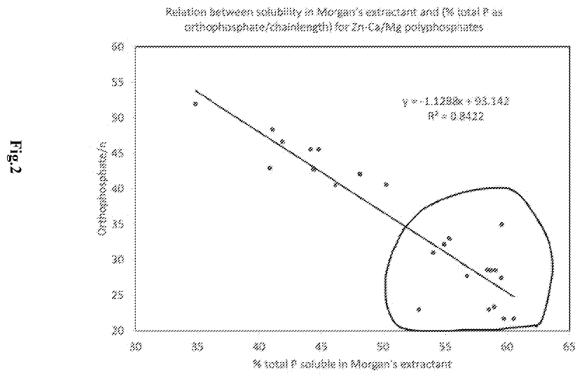

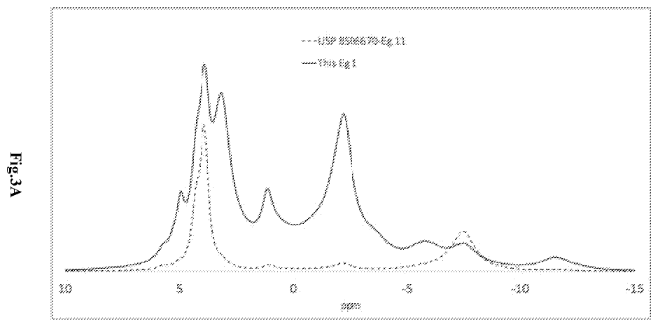

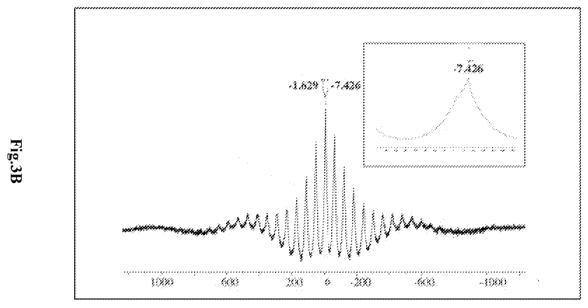

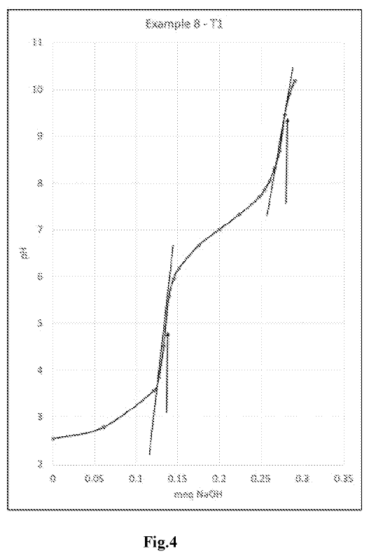

The product contained 20.9% Zn, 15.95% P and 9.6% Mg. The ñ′ was 1.78, ñ was 9.23, and the orthophosphate content was 50.8 wt %. The ratio of orthophosphate (OP): ñ′ was 28.5. In 0.1N NaHCO₃(Bicarbonate Assay), 57.62% of total P was dissolved and in Morgan's extractant (Morgan Assay) 58.68% of total P was dissolved and 81.7% of total Zn was dissolved. This product was used for field trials (FIG. 1A).

### Example 4: Zinc Polyphosphate

The fertilizer of this example was produced at lower final temperatures (Tf) of 153° C. instead of 158° C. as in Example 1. In a 2 L beaker phosphoric acid (504 g, 58% P₂O₅) was taken. This was placed in an oil bath (initially at 160° C.) and heated to Tp of 130° C. (instead of 143° C. as in Example 1). Then 204 g of ZnO (79.8% Zn) was added to it with stirring. The reaction was exothermic, and the temperature of the liquid rose to 145° C. (Te). Heating was continued till the liquid temperature reached 153° C. (Tf). Total heating period was 40 min. The beaker was removed from the oil bath. The product was neutralized and processed as described in Example 1.

The product contained 21.2% Zn, 15.7% P and 9.4% Mg. The ñ′ was 1.68, ñ was 8.20, and the orthophosphate content was 54.1 wt %. The ratio of orthophosphate to chain length, OP: ñ′, was 32.2. In 0.1N NaHCO₃(Bicarbonate Assay) 55.16% of total P was dissolved and in Morgan's extractant (Morgan Assay) 54.9% of total P was dissolved and 67.48% of total Zn was dissolved. This product was used for field trials (FIGS. 1A and 1B)

### Example 5: Zinc Polyphosphate

The fertilizer of this example was similar to that in Example 1 except that water was added to the acid to make it more dilute. In a 2 L beaker phosphoric acid (504 g, 58% P₂O₅) was taken and 10 mL water was added to it to obtain an acid concentration of 56.9% P₂O₅. The remaining process was as described in Example 1. After addition of ZnO, temperature of the liquid rose to 148° C. (Te). Heating was continued till the liquid temperature reached 158° C. (Tf). The heating period was 58 min. This is significantly higher than in Example 1 where no water was added. It illustrates that dilute acid increases the reaction period. The beaker was removed from the oil bath. The product was neutralized and processed as described in Example 1.

The product contained 20% Zn, 15.7% P and 9.4% Mg. The ñ′ was 1.72, ñ was 5.64, and the orthophosphate content was 49.2 wt %. The ratio of orthophosphate to chain length, OP: ñ′, was 28.6. In 0.1N NaHCO₃(Bicarbonate Assay) 58.08% of total P was dissolved and in Morgan's extractant (Morgan Assay) 58.4% of total P was dissolved. This product was used for field trials (FIG. 1B).

### Example 6: Zinc Polyphosphate

The fertilizer of this example was similar to that in Example 1 except that the ratio of P to Zn was higher. Here, a Zn:P molar ratio of 1:1.73 was used. In a 2 L beaker phosphoric acid (527 g, 58% P₂O₅) was taken, placed in an oil bath initially at 160° C. and heated to Tp of 143° C. Then 10 mL water was added to it followed by 204 g of ZnO (79.8% Zn) with stirring. The reaction was exothermic and the temperature of the liquid rose to 147° C. Heating was continued till the liquid temperature reached 158° C. Total time required for heating was 55 min. The beaker was removed from the oil bath and 210 mL water was added to it. The product was poured into a slurry of 157 g magnesite in 290 mL water and then processed as described in Example 1.

The product contained 19.7% Zn, 16.1% P and 9.6% Mg. The ñ′ was 1.62, ñ was 5.89, and the orthophosphate content was 53.5 wt %. The ratio of orthophosphate: ñ′ was 33. In 0.1N NaHCO₃(Bicarbonate Assay) 54.81% of total P was dissolved and in Morgan's extractant (Morgan Assay) 55.31% of total P was dissolved. The solubility properties have reduced due to higher proportion of acid to Zn. This product was used for field trials (FIG. 1B).

### Example 7: Zinc Polyphosphate

The fertilizer of this example was like that in Example 1 except that the ratio of P to Zn was lower. Here, a Zn:P molar ratio of 1:1.54 was used. In a 2 L beaker phosphoric acid (470.4 g 58% P₂O₅) was taken and heated in an oil bath (initially at 160° C.) to a Tp of 143° C. as in Example 1. Then 204 g of ZnO (79.8% Zn) was added to it with stirring. The reaction was exothermic, and the temperature of the liquid rose to 154° C. (Te). Heating was continued till the liquid temperature reached 158° C. (Tf). Total heating period was 42 min. The beaker was removed from the oil bath and 190 mL water was added to it after a few minutes when the temperature reached 150° C. The product was neutralized with 144 g magnesite in 270 mL water. Subsequently, it was processed as described in Example 1.

The product contained 20.7% Zn, 15.1% P and 9.3% Mg. The ñ′ was 1.46, ñ was 4.38, and the orthophosphate content was 59.3 wt %. In 2% citric acid 97% of P was dissolved. In 0.1N NaHCO₃(Bicarbonate Assay), 48.71% of total P was dissolved and in Morgan's extractant (Morgan Assay) 50.23% of total P was dissolved and 71.46% of total Zn was dissolved. Here it is seen that when the Zn:P ratio is reduced, keeping other process parameters constant, the solubility of the product in extractants reduces.

### Example 8: Zinc Polyphosphate

The fertilizer of this example was produced in a pilot plant. Here, a Zn:P molar ratio of 1:1.65 was used. A glass reactor equipped with a stirrer and jacketed for oil heating using thermic fluid was used. Phosphoric acid (93.5 kg, 61% P₂O₅) was pumped into it and the acid was heated to 143° C. (Tp). Then 39.8 kg of ZnO (79.8% Zn) was added to it with stirring. The reaction was exothermic, and the temperature of the liquid rose to 151° C. (Te). Heating was continued till the liquid temperature reached 153° C. (Tf). Total time to heat starting from oil at room temperature was 180 min. Here, time periods are longer because volumes are higher. In this example, the cut-off temperature was lower than in Example 1 because for such large volumes, the heating time to raise the temperature from 151° C. to 153° C. was considerably more than with small volumes of reactants in a beaker. Then the heating was cut off and 14 L water was added to the liquid with stirring. The liquid was drained into a paddle mixer containing 72 L water to which 28.3 kg magnesite was added with constant mixing. The slurry was mixed for about 15 min and then drained into steel trays. It was subsequently dried in an oven at 80° C. and the pulverized to 100 mesh (150-micron). The pH of the dried product was 5.98.

The product contained 21.3% Zn, 15.5% P and 9% Mg. The ñ′ was 1.82, ñ was 10.22, and the orthophosphate content was 50 wt %. The ratio of orthophosphate (OP): ñ′ was 27.5. In a Water Solubility Assay 0.05% of total Zn was dissolved. In 0.1N NaHCO₃ (Bicarbonate Assay) 57.79% of total P was dissolved and in Morgan's extractant (Morgan Assay) 59.52% of total P was dissolved and 77.71% of total Zn was dissolved. NMR spectrum of this product is shown in FIG. 3a. For comparison, the NMR of a product described in U.S. Pat. No. 8,506,670 (Example 11) is also shown. This product was used for field trials (FIGS. 1A and 1B).

### Example 9: Zinc Polyphosphate

The fertilizer of this example was similar to that in Example 1 except that the final temperature (Tf) was higher. Here, a Zn:P molar ratio of 1:1.65 was used. In a 2 L beaker phosphoric acid (504 g 58% P₂O₅) was taken and heated in an oil bath (initially at 160° C.) to 153° C. as in Example 1. Then, 204 g of ZnO (79.8% Zn) was added to it with stirring. The reaction was exothermic, and the temperature of the liquid rose to 162° C. (Te). Heating was continued for 5 min more till the liquid temperature reached 165° C. (Tf). Total heating time required was 85 min. The beaker was removed from the oil bath and at 150° C., 200 mL of water was added to it. The product was neutralized and processed as described in Example 1. The pH of the dried product was 7.65.

The product contained 21.6% Zn, 15.7% P and 9.4% Mg. The ñ′ was 1.98, ñ was 7.54, and the orthophosphate content was 43.0 wt %. The ratio of orthophosphate (OP): ñ′ was 21.7. In a Water Solubility Assay 0.07% of total Zn was dissolved in 0.1N NaHCO₃ (Bicarbonate Assay), 58.71% of total P was dissolved and in Morgan's extractant (Morgan Assay) 59.73% of total P was dissolved and 69.97% of total Zn was dissolved.

### Example 10: Zinc Polyphosphate

The fertilizer of this example was similar to that in Example 1 except thatsmaller volumes were used. The Zn:P molar ratio used here was 1:1.7. In a 2 L beaker phosphoric acid (246 g, 58% P₂O₅) was taken and heated in an oil bath (initial temperature 160° C.) to 143° C. (Tp). Then 99 g of ZnO (79.9% Zn) was added to it with stirring. The liquid temperature after addition of ZnO was 151° C. (Te). Heating was continued for 15 min more till the liquid temperature reached 158° C. Total time required was 55 min. The beaker was removed from the oil bath. The suspension was neutralized with magnesite (60 g in 140 mL water) Total time required was 55 min. The product was processed as described in Example 1.

Notably, the purpose of this example was to compare the time required for the heating when polyphosphate is produced by the process described in Example 11 of U.S. Pat. No. 8,506,670 with the process adopted here. For the same quantities of reactants starting with the same initial temperature of oil bath, the total time required up to the stage when the beaker was removed from the oil bath after polymerization reaction was 55 min for the process of this example compared to 70 min for the process of the Example 11 of U.S. Pat. No. 8,506,670. This, even in this small batch size, there is a significant energy savings by using the process of this disclosure.

The product contained 20.9% Zn, 15.7% P and 8.1% Mg. The number average chain length of the polyphosphate including orthophosphate (ñ′) was 1.95, number average chain length of the polyphosphate excluding orthophosphate (ñ) was 9.54, and the orthophosphate (OP) content was 45.61 wt % (Table 1). In 0.1N NaHCO₃ (Bicarbonate Assay), 57.69% of total P was dissolved and in Morgan's extractant (Morgan Assay) 57.88% of total P was dissolved. In contrast the product of Example 11 of U.S. Pat. No. 8,506,670 showed that % total P soluble in NaHCO₃(Bicarbonate Assay) was 46.8% and in Morgan's extractant, it was 48.16%. These were significantly lower than the solubility of the product of this Example 10. Thus, the addition of water during reaction not only increases heating period but also reduces solubility properties and thereby produces a product with sub-optimal properties. The values for ñ′, ñ and orthophosphate for the product of Example 11 of U.S. Pat. No. 8,506,670 were also suboptimal at 1.48, 7.17 and 62.3 respectively and the ratio of orthophosphate (OP): ñ was 42.1.

### Example 11: Zinc Polyphosphate

The fertilizer of this example was similar to that in Example 3 except that the heating rate was much slower and the Tp was higher. Here the Tp was 153° C. After the addition of ZnO, the temperature of the liquid rose to 162° C. Heating was continued till the liquid temperature reached 165° C. (Tf). Total heating period was 125 min. Increase in heating time was because of slow heating that was done. The beaker was removed from the oil bath. The product was neutralized and processed as described in Example 3.

The product contained 20.1% Zn, 15.7% P and 9.4% Mg. The ñ′ was 1.78, ñ was 9.23, and the orthophosphate content was 50.8 wt %. In 0.1N NaHCO₃(Bicarbonate Assay), 58.69% of total P was dissolved and in Morgan's extractant (Morgan Assay) 59.07% of total P was dissolved. The product of Example 3 showed slightly lower solubilities of 57.62% and 58.68% respectively. However, this small increase in solubility was at the cost of longer heating periods.

### Example 12: Zinc Polyphosphate

The fertilizer of this example was similar to that in Example 10 except that when the acid was heated a watch glass was placed over the beaker to reduce water loss from the system so there would be more water in the system when the temperature of 143° C. was attained. The Zn:P molar ratio used here was 1:1.59. In a 2 L beaker phosphoric acid (246 g, 58% P₂O₅) was taken and heated in an oil bath (initial temperature 160° C.) to a Tp of 143° C. with a watch glass placed over it. Then 99 g of ZnO (79.8% Zn) was added to it with stirring. Proportion of reactants was the same as in Example 10. After the addition of ZnO at the temperature of the liquid rose to 145° C. (Te); in comparison, the Te was 151° C. for Example 10. Heating was continued till the liquid temperature reached 158° C. Total heating period was 60 min; in comparison the heating period was 55 min in the process of example 10. Thus, heating period increases if the acid is preheated in a closed system. The beaker was removed from the oil bath. This may be attributed to slower water evaporation rate from the acid when it is heated in an open vessel as compared to heating in a closed vessel. The product was neutralized and processed as described in Example 1.

The product contained 20.7% Zn, 15.7% P and 8.0% Mg. In 0.1N NaHCO₃ (Bicarbonate Assay), 57.59% of total P was dissolved and in Morgan's extractant (Morgan Assay) 58.29% of total P was dissolved.

### Example 13: Zinc Polyphosphate

The fertilizer of this example was similar to that in Example 12 except that the final temperature was lower. Here the reaction was done up to a temperature of 153° C. instead of 158° C. (as in Example 12). As in Example 12, when the acid was heated a watch glass was placed over the beaker to reduce water loss from the system. Proportion of reactants was the same as in Example 12. After the addition of ZnO, the temperature of the liquid rose to 145° C. Heating was continued till the temperature reached 153° C. (Tf). Total heating period was 57 min. The beaker was removed from the oil bath. The product was neutralized and processed as described in Example 12.

The product contained 20.8% Zn, 15.7% P and 8.1% Mg. In 0.1N NaHCO₃ (Bicarbonate Assay), 56.65% of total P was dissolved and in Morgan's extractant (Morgan Assay) 56.78% of total P was dissolved. In comparison with the product of Example 12, this product had lower solubility in NaHCO₃(Bicarbonate Assay) and Morgan's extractant (Morgan Assay).

### Example 14: Zinc Polyphosphate

The fertilizer of this example was produced at higher final temperatures (Tf) of 167° C. instead of 158° C. (as in Example 1). In a 2 L beaker phosphoric acid (504 g 58% P₂O₅) was taken. This was heated in an oil bath to 160° C. (instead of 143° C. as in Example 1). The beaker was removed from the oil bath and the liquid temperature was allowed to fall to 150° C. (Tp). Then 204 g of ZnO (79.8% Zn) was added to it with stirring. Due to exothermic reaction, the liquid temperature rose to 167° C. (Tf). The beaker was removed from the oil bath. The total heating time was 65 min. The product was neutralized and processed as described in Example 1. The pH of the dried product was 7.07.

The product contained 20.1% Zn, 15.8% P and 9.4% Mg. The ñ′ was 1.77, ñ was 6.94, and the orthophosphate content was 49.1 wt %. The ratio of orthophosphate (OP): ñ′ was 27.7. In 0.1N NaHCO₃(Bicarbonate Assay), 56.41% of total P was dissolved and in Morgan's extractant (Morgan Assay) 56.79% of total P was dissolved.

### Example 15: Calcium Polyphosphate

The fertilizer of this example was produced using calcium oxide and orthophosphoric acid (58% P₂O₅). In a 2 L beaker phosphoric acid (504 g) was taken. This was heated in an oil bath (initial temperature 160° C.) to 153° C. Then a slurry of 6 g magnetite (69% Fe) in 6 mL water was added to it followed by 50 g of CaO (70% Ca); the solution was continuously stirred. The reaction was exothermic, and the temperature of the liquid rose to 156° C. (Te=Tf). The total heating time was 63 min. The beaker was removed from the oil bath. 300 mL water was added to the reacted liquid (calcium polyphosphate) and stirred. Addition of water prevents the liquid become too viscous and solidifying, that would make material transfer very difficult. In a 5 L beaker, 600 mL water was taken, and 373 g calcite powder (39% Ca) was taken and the calcium polyphosphate reaction mixture was poured into it with stirring. There was much frothing, and the reaction was exothermic. The product solidified in about 20 min. It was taken in steel trays and heated in an oven at 80° C. The dried product was ground to pass through 180 micron sieve. The pH of the dried product was 6.22.

The product contained 24% Ca, 21% P and 0.6% Fe. The ñ′ was 1.57, ñ was 4.8, and the orthophosphate content was 53.85 wt %. The ratio of orthophosphate (OP): ñ′ was 34.3. In a Water Solubility Assay 1.2% of total P was dissolved and 6.17% of total Ca was dissolved. In 0.1N NaHCO₃(Bicarbonate Assay), 59.80% of total P was dissolved and in Morgan's extractant (Morgan Assay) 59.23% of total P was dissolved. In 0.2% citric acid, 99.4% of total P was dissolved. Field trial assessment was conducted with this sample (FIG. 1C).

### Example 16: Iron Polyphosphate

The fertilizer of this example was produced using magnetite (Fe₃O₄, 69% Fe) and orthophosphoric acid (61% P₂O₅). In a 10 L beaker phosphoric acid (1644 g) was taken. This was placed in a water bath at room temperature (28° C.). Then a slurry of 400 g magnetite in 400 mL water was added to it with stirring (Tp=28° C.). The reaction was exothermic, and the temperature of the suspension rose to 87° C. (Te=Tf). The mixture was stirred for about 10 min. To prevent further rise of temperature, 1 L water was added and stirred. Once the liquid temperature reached 65° C. it was slowly added to a slurry of 380 g magnesite in 2.5 L water. There was much frothing and heat was evolved. After about 5 min stirring, the slurry solidified. It was taken in steel trays and heated in an oven at 60° C. The dried product was ground to pass through 180-micron sieve.

The product contained 11.4% Fe, 16.7% P, 8.7% Mg. The ñ′ was 1.84, ñ was 8.46, and the orthophosphate content was 48.1 wt %. The ratio of orthophosphate (OP): ñ′ was 26.1. In a Water Solubility Assay, 9.1% of total P and 0.21% of total Fe was dissolved. In 0.1N NaHCO₃(Bicarbonate Assay), 60.12% of total P was dissolved and in Morgan's extractant (Morgan Assay) 59.52% of total P and 58.14% of total Fe was dissolved.

### Example 17: Manganese Polyphosphate

The fertilizer of this example was produced using manganous oxide and orthophosphoric acid (58.5% P₂O₅). In a 5 L beaker phosphoric acid (438 g) was taken and 220 mL water was added to it. This was heated in an oil bath (initial temperature 160° C.) to 60° C. (Tp). Then a slurry of 220 g manganous oxide (60% Mn) in 550 mL water was added to it and stirred. Due to exothermic reaction, temperature of the suspension rose to 98° C. (Te=Tf). It was further heated to 101° C. It was then neutralized with a suspension of 95 g magnesite in 150 mL water. There was much frothing, and the reaction was exothermic. The product soon solidified. It was taken in steel trays and heated in an oven at 70° C. The dried product was ground to pass through 180 micron sieve. The pH of the dried product was 5.25.

The product contained 18% Mn, 14.9% P and 6.4% Mg. The ñ′ was 1.6, ñ was 5.87, and the orthophosphate content was 55.1 wt %. The ratio of orthophosphate (OP) to chain length, ñ′, was 34.4. In a Water Solubility Assay, 8.4% of total P and 2.9% of total Mn was dissolved. In 0.1N NaHCO₃(Bicarbonate Assay), 59.97% of total P was dissolved and in Morgan's extractant (Morgan Assay) 59.64% of total P was dissolved. In 2% citric acid, 99% of total P was dissolved. ³¹P NMR of this product is shown in FIG. 3B.

### Example 18: Copper Polyphosphate

The fertilizer of this example was produced using copper hydroxide carbonate (54% Cu) and orthophosphoric acid (58% P₂O₅). In a 500 mL beaker phosphoric acid (42 g, 25 mL) was taken. This was heated in an oil bath (initial temperature 160° C.) to 125° C. Then a slurry of 23.9 g copper hydroxide carbonate (54% Cu) in 100 mL water was added to it and stirred. The temperature of the suspension fell to 60° C. Heating was continued till the temperature reached 103° C. It was then neutralized with a suspension of 10 g magnesite in 100 mL water. There was much frothing, and the reaction was exothermic. The product was taken in steel trays and heated in an oven at 70° C. The dried product was ground to pass through 180-micron sieve. The pH of the dried product was 6.56.

The product contained 18.6% Cu, 15.3% P and 6.6% Mg. The ñ′ was 1.87, ñ was 5.41, and the orthophosphate content was 42.9 wt %. The ratio of orthophosphate, OP, to chain length, ñ′, was 22.9. In a Water Solubility Assay, 0.4% of total Cu was dissolved. In 0.1N NaHCO₃(Bicarbonate Assay), 60.52% of total P was dissolved and in Morgan's extractant (Morgan Assay) 59.28% of total P was dissolved. In 2% citric acid, 99.2% of total P was dissolved.

### Example 19: Zinc Polyphosphate

The fertilizer of this example was similar to that in Example 10 except that the reaction temperature was lower. Here the final temperature was 153° C. instead of 158° C. In a 2 L beaker phosphoric acid (246 g, 146 mL, 58.5% P₂O₅) was taken and heated oil bath (initial temperature 160° C.) to 143° C. (Tp). Then 99 g of ZnO (79.9% Zn) was added to it with stirring. The liquid temperature after addition of ZnO was 151° C. Heating was continued for 5 min more till the liquid temperature reached 153° C. Total time required was 45 min. The beaker was removed from the oil bath. The suspension was neutralized with magnesite (60 g in 140 mL water) The product was processed as described in Example 1.

The product contained 19.7% Zn, 15.7% P and 7.6% Mg. In 0.1N NaHCO₃ (Bicarbonate Assay), 55.52% of total P was dissolved and in Morgan's extractant (Morgan Assay) 56.60% of total P was dissolved.

Notably, the purpose of this example was to compare the solubility properties of the product when heating temperatures are lower. It is seen that when the polyphosphate is produced at a higher temperature of 158° C. (Example 10), it has a higher solubility in both NaHCO₃(Bicarbonate Assay) as well as in Morgan's extractant (Morgan Assay) (Table 1).

### Comparative Example 20

Comparative Example 20.1: Zinc pyrophosphate was prepared from sodium pyrophosphate and zinc sulfate by precipitation. To a solution of sodium pyrophosphate in water, zinc sulfate solution was added, and the suspension shaken for 30 min. The precipitate was filtered and washed with water till free of sulfate. It was dried at 80° C. and ground to 150 microns.

Comparative Example 20.2: Zinc tripolyphosphate was also prepared similarly, using sodium tripolyphosphate instead of sodium pyrophosphate.

Comparative Example 20.3: Zinc magnesium orthophosphate (Zn:P=1:1.67) was prepared from phosphoric acid and magnesite. Phosphoric acid (50 mL) was diluted with 33 mL water and placed in a water bath. To it, 34 g ZnO was added with stirring. To this, a suspension of 32 g magnesite in 60 mL water was added. The product was dried at 80° C. and ground to 150 microns. The product contained 20.58% total Zn and 15.4% total P. In 0.1N NaHCO₃(Bicarbonate Assay), 32.31% of total P was dissolved and in Morgan's extractant (Morgan Assay) 34.07% of total P and 51.49% of total Zn was dissolved. This product was used for field trials (FIG. 1A).

Comparative Example 20.4: Zinc, iron and manganese polyphosphates of U.S. Pat. No. 8,506,670, Examples 1, 11, 12, 13, 14, 15, 21, 23, 19, 26 were produced exactly as described therein. These are identified herein as Examples 20.4a, 20.4b, 20.4c, 20.4d, 20.4e, 20.4f, 20.4g, 20.4h, 20.4i, 20.4j, respectively. The process of U.S. Pat. No. 8,506,670 example 11 (Comparative Example 20.4b herein) took 70 min of heating time which is 40% more heating compared to the same Tf in Example 1. Another process was worked as described in of U.S. Pat. No. 8,506,670 Example 13 (Comparative Example 20.4d herein) and this required 50% more heating time compared to Example 1. Samples from Comparative Examples 20.4a, b, d were used for field trials (FIG. 1B).

Another iron-manganese fertilizer was produced as described in Bhattacharya et al (2007) and identified as Comparative Example 20.4k. A copper ammonium polyphosphate was produced as described in Ray et al. (1997) and identified as Comparative Example 20.41. Solubilities of these products in NaHCO₃(Bicarbonate Assay) and Morgan's extractant (Morgan Assay) are shown in Table 1.

Comparative Example 20.5: A mixed multipolyphosphate containing ortho-pryo-tripolyphosphates was prepared using a solution of 10 g KH₂PO₄, 4.92 g sodium pyrophosphate (Na₄P₂O₇·10H₂O) and 1.803 g sodium tripolyphosphate (Na₅P₃O₁₀) was also prepared similar to that in Examples 20.2 and 20.3. To this solution, a solution of 18.28 g ZnSO₄·7H₂O and 19.98 g MgSO₄·7H₂O was added. This was placed in a shaker for 30 min. This was filtered, washed and dried at 80° C. The product contained 21.6% Zn and 15.8% P. In 0.1N NaHCO₃(Bicarbonate Assay), 29.46% of total P was dissolved and in Morgan's extractant (Morgan Assay) 31.36% of total P and 25.74% of total Zn was dissolved. This product was used for field trials (FIG. 1A).

Comparative Example 20.6: Calcium polyphosphates of U.S. Pat. No. 9,017,443 Examples 11, 26, 15, 18, 19, 1, 9, 14, 26, 27, 30) were synthesized as stated therein. These are identified as Comparative Examples 20.6a, 20.6b, 20.6c, 20.6d, 20.6e, 20.6f, 20.6g, 20.6h, 20.6i, 20.6j, 20.6k respectively. Field trial assessment was conducted with the samples of Comparative Examples 20.6 a, 20.6 c, and 20.6g (FIGS. 1C and 1D). Yields are lower with the products of U.S. Pat. No. 9,017,443 compared to the products of this disclosure (Examples 40, 15).

Comparative Examples 20.7a & 20.7b: Calcium and ammonium zinc polyphosphates were prepared as described in Ray et al. 1993). These are labelled Comparative Examples 20.7a and 20.7b.

Comparative Example 20.8a: A Zinc orthophosphate was prepared from 50 g ZnO and 50 g phosphoric acid (61% P₂O₅). The acid in an Erlenmeyer flask was diluted with 35 mL water and was placed in a water bath. ZnO was added to it with stirring. The suspension was placed on a shaker for 30 min, then filtered, washed and the precipitate was dried at 70° C.

Comparative Example 20.8b was a Mn orthophosphate prepared by mixing phosphoric acid (15.6 g) with 6 mL water and adding MnSO₄·H₂O (33.8 g) in 30 mL water and neutralizing the suspension with dilute NaOH to pH 7. It was further processed as in Comparative Example 20.8a.

Comparative Example 20.8c was a Mn—Mg orthophosphate prepared by mixing phosphoric acid (84 g), water 33 mL and MnSO₄·H₂O (81.24 g) and neutralizing the suspension of magnesite (30 g) in 50 mL water. It was further processed as in Comparative Example 20.8a.

Comparative Example 20.8d was a Cu orthophosphate prepared by mixing phosphoric acid (15.6 g) and copper hydroxide carbonate (22.4 g) in 40 mL water and neutralizing the suspension with dilute NaOH to pH 7. It was further processed as in Comparative Example 20.8a.

Comparative Example 20.8e was a Cu—Mg orthophosphate prepared by mixing phosphoric acid (84 g) and 33 mL water with copper hydroxide carbonate (36 g) in 60 mL water and neutralizing the suspension with magnesite (37 g) in 58 ml water. It was further processed as in Comparative Example 20.8a.

Comparative Example 20.8f was a calcium orthophosphate prepared by mixing phosphoric acid (23.4 g) and 9 mL water with calcium oxide (16.8 g) in 60 mL water. It was further processed as in example 20.8a.

Comparative Example 20.9: A zinc calcium orthophosphate was prepared as in Comparative Example 20.8a, except that 50 g of phosphoric acid diluted with 18 mL water was mixed with 18 g ZnO and then with 43 g calcite in 60 mL water. The product was processed as in Example 20.8a.

Comparative Example 20.10: A copper calcium polyphosphate was prepared as described in Ray et al (1997).

Comparative Example 20.11: Magnesium and ammonium iron polyphosphate fertilizers were prepared as described in Chandra et al. (2009); these are labelled 20.11a and 20.11b respectively.

Comparative Example 20.12: Zinc polyphosphate was prepared as described in Varadachari et al. (2009).

Comparative Example 20.13: A Zn—Fe—Mn—Cu polyphosphate was prepared as described in Bandopadhyay et al. (2014).

Comparative Example 20.14: A Mg polyphosphate was prepared as described in PCT/IB2021/060786 Example 2a.

### Comparative Example 21: Zinc Polyphosphate

The fertilizer of this example was similar to that in Example 1 except that the reaction temperature was much lower. Here the final temperature was 140° C. instead of 158° C. In a 2 L beaker orthophosphoric acid (58% P₂O₅). In a 2 L beaker phosphoric acid (504 g) was taken. This was heated in an oil bath to 110° C. (Tp). Then 204 g of ZnO (79.8% Zn) was added to it with stirring. The reaction was exothermic, and the temperature of the liquid rose to 140° C. (Te=Tf). The total heating period was 20 min. The beaker was removed from the oil bath. The suspension was neutralized with magnesite (150 g in 280 mL water). The product was processed as described in Example 1. The pH of the neutralized, dried product was 5.28.

The product contained 20.1% Zn, 15.8% P and 9.5% Mg. The ñ′ was 1.41, ñ was 11.2, and the orthophosphate content was 68.2 wt %. In a Water Solubility Assay, 0.1 wt % of total Zn was dissolved.

In 0.1N NaHCO₃(Bicarbonate Assay), 39.63% of total P was dissolved and in Morgan's extractant (Morgan Assay) 41.09% of total P was dissolved (Table 1).

Notably, the purpose of this example was to compare the solubility properties of the product when heating temperatures are lower. It is seen that when the polyphosphate is produced at a higher temperature of 158° C. (Example 10), it has a higher solubility in both NaHCO₃(Bicarbonate Assay) as well as in Morgan's extractant (Morgan Assay).

### Comparative Example 22: Zinc Polyphosphate

The fertilizer of this example was similar to Example 1, except that it was produced at lower final temperatures of 145° C. instead of 153° C. In a 2 L beaker phosphoric acid (504 g, 58% P₂O₅) was taken. This was heated in an oil bath to 130° C. (Tp). Then 204 g of ZnO (79.8% Zn) was added to it with stirring. The reaction was exothermic, and the temperature of the liquid rose to 145° C. (Te=Tf). The beaker was removed from the oil bath. The product was neutralized and processed as described in Example 1.

The product contained 20% Zn, 15.7% P and 9.4% Mg. The ñ′ was 1.44, ñ was 9.33, and the orthophosphate content was 65.6 wt %. In 0.1N NaHCO₃(Bicarbonate Assay), 42.54% of total P was dissolved and in Morgan's extractant (Morgan Assay) 44.13% of total P and 60.16% of total Zn was dissolved (Table 1). The product was used for field trials (FIG. 1A)

### Comparative Example 23: Zinc Polyphosphate

The fertilizer of this example was similar to Examples 1 and 19, except that water was added after the addition of ZnO and the final temperature was lower than in example 1. In a 2 L beaker phosphoric acid (504 g, 58% P₂O₅) was taken. This was heated in an oil bath (initial temperature 160° C.) to 143° C. (Tp). Then 204 g of ZnO (79.8% Zn) was added to it with stirring. The reaction was exothermic, and the temperature of the liquid rose to 151° C. (Te). Then 10 mL water was added whereupon the liquid temperature fell to 140° C. Heating was continued till the liquid temperature reached 153° C. (Tf). The beaker was removed from the oil bath. The product was neutralized and processed as described in Example 1. Total time for this reaction was 55 min compared to 45 min for Example 19.

The product contained 20.1% Zn, 15.7% P and 9.4% Mg. The ñ′ was 1.49, ñ was 5.85, and the orthophosphate content was 60.4 wt %. In 0.1N NaHCO₃(Bicarbonate Assay), 45.81% of total P was dissolved and in Morgan's extractant (Morgan Assay) 46.13% of total P was dissolved. This example shows that addition of water after adding ZnO significantly reduced solubility of the product.

### Example 24: Zinc Polyphosphate

The fertilizer of this example was similar to Example 1, except that the molar ratio of Zn:P was 1:1.59. In a 2 L beaker phosphoric acid (504 g, 58% P₂O₅) was taken. This was heated in an oil bath (initial temperature 160° C.) till the temperature of the liquid was 143° C. (Tp). Then 212 g of ZnO (79.8% Zn) was added to it with stirring. The reaction was exothermic, and the temperature of the liquid rose to 153° C. (Te). Heating was continued till the temperature of the liquid reached 158° C. Total time of reaction was 50 min. The beaker was removed from the oil bath and 200 mL water was added to it. The mixture was poured into a suspension of 150 g magnesite in 280 mL water and stirred. It was further processed as described in Example 1.

The product contained 21.3% Zn, 15.8% P and 9.5% Mg. In a Water Solubility Assay, 7.22% of total P was dissolved. In 0.1N NaHCO₃(Bicarbonate Assay), 57.12% of total P was dissolved and in Morgan's extractant (Morgan Assay) 57.62% of total P and 81.9% of total Zn was dissolved. Reducing Zn:P ratio slightly reduces solubility as seen by the comparison with Example 1 (Table 1).

### Example 25: Copper Polyphosphate

The fertilizer of this example was produced by a process similar to that in Example 18, except that less water was used with the copper carbonate. In a 500 mL beaker phosphoric acid (86.6 g) was taken. This was heated in an oil bath (initial temperature 160° C.) to 125° C. Then a slurry of 50 g copper hydroxide carbonate (54% Cu) in 50 mL water was added to it and stirred. The temperature of the suspension fell to 105° C. Heating was continued till the temperature reached 110° C. It was then neutralized with a suspension of 17 g magnesite in 50 mL water. There was much frothing, and the reaction was exothermic. The product was taken in steel trays and heated in an oven at 70° C. The dried product was ground to pass through 180-micron sieve.

The product contained 17.2% Cu, 15.5% P and 6.5% Mg. The number average chain length of the polyphosphate including orthophosphate (ñ′) was 1.72, number average chain length of the polyphosphate excluding orthophosphate (ñ) was 8.0, and the orthophosphate (OP) content was 52 wt % (Table 1). In 0.1N NaHCO₃(Bicarbonate Assay) 57.23% of total P was dissolved. In 2% citric acid, 99.2% of total P was dissolved (Table 1).

### Example 26: Zinc Polyphosphate

The fertilizer of this example was similar to Example 24, except that acid was heated to a higher Tp of 147° C. In a 2 L beaker phosphoric acid (504 g, 58% P₂O₅) was taken. This was heated in an oil bath (initial temperature 160° C.) till the temperature of the liquid was 147° C. (Tp). Then 212 g of ZnO (79.8% Zn) was added to it with stirring. The reaction was exothermic, and the temperature of the liquid rose to 160° C. (Te). The reactants were stirred for a min and the beaker was removed from the oil bath. Total time of heating was 45 min. 200 mL water was added to the reactants in the beaker. The contents were poured into a suspension of magnesite (150 g) in 280 mL water. The neutralized product solidified in a few minutes. It was further processed as described in Example 1. The pH of the dried product was 5.88. The product contained 21.3% Zn and 15.5% P. Solubility in NaHCO₃(Bicarbonate Assay) and Morgan's extractant (Morgan Assay) are shown in Table 1. The field performance of this sample is shown in FIG. 1B.

### Example 27: Zinc Polyphosphate

The fertilizer of this example was similar to Example 26, except that it was neutralized with less magnesite. In a 2 L beaker phosphoric acid (504 g, 58% P₂O₅) was taken. This was heated in an oil bath (initial temperature 160° C.) till the temperature of the liquid was 147° C. (Tp). Then 212 g of ZnO (79.8% Zn) was added to it with stirring. The reaction was exothermic, and the temperature of the liquid rose to 160° C. (Te). The reactants were stirred for a min and the beaker was removed from the oil bath. Total time of heating was 45 min. 200 mL water was added to the reactants in the beaker. The contents were poured into a suspension of magnesite (140 g) in 260 mL water. The neutralized product did not solidify and had water at the surface compared to products where more magnesite was added (Example 26). It was further processed as described in Example 1. The pH of this product was 4.91.

The product contained 21% Zn, 15.8% P and 9.5% Mg. In 0.1N NaHCO₃ (Bicarbonate Assay), 54.45% of total P was dissolved and in Morgan's extractant (Morgan Assay) 55.59% of total P was dissolved. Neutralizing with less base has significantly reduced solubility in NaHCO₃(Bicarbonate Assay) and Morgan's extractant (Morgan Assay) (Table 1).

### Example 28: Zinc Polyphosphate

The fertilizer of this example was similar to Example 26, except that water was added to the system after addition of ZnO and less magnesite was used for neutralization. In a 2 L beaker phosphoric acid (504 g 58% P₂O₅) was taken. This was heated in an oil bath (initial temperature 160° C.) till the temperature of the liquid was 147° C. (Tp). Then 212 g of ZnO (79.8% Zn) was added to it with stirring. The reaction was exothermic, and the temperature of the liquid rose to 160° C. (Te). Then 15.2 mL water was added; the liquid temperature fell to 150° C. Heating was continued till the liquid temperature reached 158° C. Total time of heating was 57 min. Therefore, is seen that an excess of 12 min heating is required in the process of Example 26 compared to the process described here. Addition of water after ZnO addition increases heating periods considerably. The beaker was removed from the oil bath. After removing from the oil bath, 200 mL water was added to the reactants in the beaker. The contents were poured into a suspension of magnesite (140 g) in 260 mL water. This sample was also neutralized with less magnesite compared to that in Example 24. The neutralized product did not solidify and had water at the surface compared to products where more magnesite was added (Example 26). It was further processed as described in Example 1.

The product contained 21.1% Zn, 15.9% P and 8.9% Mg. In 0.1N NaHCO₃ (Bicarbonate Assay), 54.37% of total P was dissolved and in Morgan's extractant (Morgan Assay) 55.25% of total P was dissolved.

### Example 29: Zinc Polyphosphate

The fertilizer of this example was similar to Example 26, except that the acid was more dilute, and more magnesite was added for neutralization. In a 2 L beaker phosphoric acid (504 g 47.8% P₂O₅) was taken. This was heated in an oil bath (initial temperature 160° C.) till the temperature of the liquid was 147° C. (Tp). Then 188 g of ZnO (79.8% Zn) was added to it with stirring. The reaction was exothermic, and the temperature of the liquid rose to 160° C. (Te). The beaker was removed from the oil bath. Total time of heating was 71 min. Therefore, is seen that an excess of 26 min heating is required in this process compared to the process described in Example 26, because the acid was more dilute. After removing from the oil bath, 177 mL water was added to the reactants in the beaker. The contents were poured into a suspension of magnesite (159 g) in 297 mL water. The product solidified very rapidly within 5 min. It was further processed as described in Example 1.

The product contained 20.4% Zn, 15.4% P and 11% Mg. In 0.1N NaHCO₃ (Bicarbonate Assay), 56.45% of total P was dissolved and in Morgan's extractant (Morgan Assay) 57.03% of total P was dissolved. This example shows that with more dilute acid, heating period increases; solubilities do not differ significantly.

### Example 30: Zinc Polyphosphate

The fertilizer of this example was similar to Example 26, except that a mixture of magnesite and calcite was used for neutralization. It is also for comparison with example 27. In a 2 L beaker phosphoric acid (504 g, 58% P₂O₅) was taken. This was heated in an oil bath (initial temperature 160° C.) till the temperature of the liquid was 147° C. (Tp). Then 212 g of ZnO (79.8% Zn) was added to it with stirring. The reaction was exothermic and the temperature of the liquid rose to 165° C. (Te). The beaker was removed from the oil bath. Total time of heating was 45 min. After removing from the oil bath, 200 mL water was added to the reactants in the beaker. The contents were poured into a suspension of magnesite (140 g) and calcite (22 g, 39% Ca) in 280 mL water. The product solidified and was further processed as described in Example 1.

The product contained 21.5% Zn, 15.8% P and 8.8% Mg and 1% Ca. In 0.1N NaHCO₃(Bicarbonate Assay), 57.42% of total P was dissolved and in Morgan's extractant (Morgan Assay) 58.19% of total P was dissolved and 77.44% of total Zn was dissolved. Comparison with Example 26 shows that substitution of some magnesite by calcite does not affect product solubility; comparison with example 27 shows that increasing neutralizing base improves product solubility in NaHCO₃(Bicarbonate Assay) and Morgan's extractant (Table 1). The field performance of this sample is shown in FIG. 1B.

### Comparative Example 31: Zinc Polyphosphate

The fertilizer of this example was similar to Example 26, except that ammonia was used for neutralization instead of magnesite. In a 2 L beaker phosphoric acid (504 g, 58% P₂O₅) was taken. This was heated in an oil bath (initial temperature 160° C.) till the temperature of the liquid was 147° C. (Tp). Then 212 g of ZnO (79.8% Zn) was added to it with stirring. The reaction was exothermic, and the temperature of the liquid rose to 160° C. (Te). The beaker was removed from the oil bath. Total time of heating was 45 min. After removing from the oil bath, 200 mL water was added to the reactants in the beaker. The contents were poured into a solution of ammonia (428 mL of 25% NH₃) in 280 mL water. The product did not solidify immediately. It was oven dried and further processes as described in Example 1. The product contained 20.3% P and 26.5% Zn. The pH of the neutralized, dried product was 5.15. In a Water Solubility Assay, 1.03% of total Zn was dissolved. Comparison with Example 26 shows that neutralizing with NH₄OH as a base reduces product solubility in NaHCO₃(Bicarbonate Assay) and Morgan's extractant (Morgan Assay).

### Example 32: Zinc Polyphosphate

The fertilizer of this example was similar to Example 1, except that 50% of the Mg in magnesite was substituted by calcite during neutralization. In a 2 L beaker phosphoric acid (504 g, 58% P₂O₅) was taken. This was heated in an oil bath (initial temperature 160° C.) till the temperature of the liquid was 143° C. (Tp). Then 204 g of ZnO (79.8% Zn) was added to it with stirring; the temperature of the reactants rose to 151° C. (Te). The beaker was removed from the oil bath. Total time of heating was 50 min. After removing from the oil bath, 200 mL water was added to the reactants in the beaker. The contents were poured into a suspension of magnesite (75 g) and calcite (96 g) in 280 mL water. The product solidified in a few minutes. It was oven dried and further processed as described in Example 1. The pH of the dried product was 5.32.

The product contained 20.3% Zn, 15.9% P and 4.8% Mg and 4.7% Ca. In 0.1N NaHCO₃(Bicarbonate Assay), 55.42% of total P was dissolved and in Morgan's extractant (Morgan Assay) 56.36% of total P was dissolved. (Table 1).

### Example 33: Iron-Manganese Polyphosphate

In a beaker, 199 g of phosphoric acid (61% 61% P₂O₅) was taken, and 100 mL water was added to it. It was heated to 60° C. Then a slurry of 100 g MnO (60% Mn) in 350 mL water was added to it. Due to exothermic reaction, the temperature of the suspension rose to 90° C. In another beaker, 770 g phosphoric acid was taken and to it a slurry of 174 g magnetite (69% Fe) in 350 mL water was added with stirring. Temperature of the suspension rose to 85° C. When the temperature went down to 68° C. after about 20 min stirring, the reacted suspension containing manganese was added to the suspension of reacted magnetite followed by 450 mL water. Temperature of the system was 65° C. This reaction mixture was neutralized with a slurry of magnesite (240 g in 1.2 L water). The neutralized mass was dried at 60° C. and ground to pass through 180-micron sieve.

The product contained 8.6% Fe, 4.3% Mn, 8.1% Mg and 15.8% P. The number average chain length of the polyphosphate including orthophosphate (ñ′) was 1.71, number average chain length of the polyphosphate excluding orthophosphate (ñ) was 3.65, and the orthophosphate (OP) content was 42.6 wt % (Table 1). In Morgan extractant 54.82% of total Fe was dissolved. In 0.1N NaHCO₃(Bicarbonate Assay), 56.21% of total P was dissolved and in Morgan's extractant (Morgan Assay) 57.48% of total P was dissolved (Table 1).

### Example 34: Zinc Polyphosphate

The fertilizer of this example was similar to Example 30, except that acid was more concentrated. In a 2 L beaker phosphoric acid (504 g, 61% P₂O₅) was taken. This was heated in an oil bath (initial temperature 160° C.) till the temperature of the liquid was 147° C. (Tp). Then 212 g of ZnO (79.8% Zn) was added to it with stirring. The reaction was exothermic, and the temperature of the liquid rose to 160° C. (Te=Tf). The reactants were stirred for a min and the beaker was removed from the oil bath. Total time of heating was 45 min. 200 mL water was added to the reactants in the beaker. The contents were poured into a suspension of magnesite (140 g) and calcite (22 g, 39% Ca) in 280 mL water. The neutralized product solidified in a few minutes. It was further processed as described in Example 1. The pH of the dried product was 5.83.

The product contained 20.8% Zn, 16.5% P and 8.7% Mg and 1.1% Ca. The number average chain length of the polyphosphate including orthophosphate (ñ′) was 1.96, number average chain length of the polyphosphate excluding orthophosphate (ñ) was 9.33, and the orthophosphate (OP) content was 45.1 wt % (Table 1).

### Example 35: Zinc Polyphosphate

The fertilizer of this example was similar to Example 34, except that only magnesite was used for neutralization. In a 2 L beaker phosphoric acid (504 g, 61% P₂O₅) was taken. This was heated in an oil bath (initial temperature 160° C.) till the temperature of the liquid was 147° C. (Tp). Then 212 g of ZnO (79.8% Zn) was added to it with stirring. The reaction was exothermic, and the temperature of the liquid rose to 160° C. (Te=Tf). The reactants were stirred for a min and the beaker was removed from the oil bath. Total time of heating was 40 min. 200 mL water was added to the reactants in the beaker. The contents were poured into a suspension of magnesite (150 g) in 280 mL water. The neutralized product solidified in a few minutes. The pH of the dried product was 5.88. It was further processed as described in Example 1. The product contained 20.97% Zn, 16.6% P and 9.1% Mg. Solubility in NaHCO₃(Bicarbonate Assay) and Morgan's extractant (Morgan Assay) are shown in Table 1.

The number average chain length of the polyphosphate including orthophosphate (ñ′) was 1.95, number average chain length of the polyphosphate excluding orthophosphate (ñ) was 9.54, and the orthophosphate (OP) content was 45.61 wt % (Table 1).

### Example 36: Calcium Polyphosphate

The fertilizer of this example was similar to Example 15 except that the phosphoric acid was heated initially to 155° C. (Tp). The final temperature after addition of CaO was 160° C. (Te=Tf). Total reaction period was 125 min. The product contained 24.7% Ca, 0.59% Fe and 21.5% P. The number average chain length of the polyphosphate including orthophosphate (ñ′) was 1.65, number average chain length of the polyphosphate excluding orthophosphate (ñ) was 7.33, and the orthophosphate (OP) content was 54.17 wt % (Table 1). In 0.1N NaHCO₃(Bicarbonate Assay), 57.79% of total P was dissolved and in Morgan's extractant (Morgan Assay) 59.08% of total P was dissolved. No particular advantage was seen by increasing Tp and Tf.

### Example 37: Zinc Polyphosphate

The fertilizer of this example was prepared as in Example 35 except that less magnesite was used. Here 145 g magnesite was used for neutralization. The product contained 21.3% Zn, 16.17% P and 8.9% Mg.

### Example 38: Zinc Polyphosphate

This example was to compare with Example 8, wherein the product was obtained in large scale production and required much higher heating periods. Here the process was done with smaller quantities in a 2 L beaker as in example 35. Here phosphoric acid (504 g, 61% P₂O₅) was reacted with ZnO (212 g) with faster heating rates. The phosphoric acid was heated initially to 143° C. (Tp). The final temperature after addition of ZnO was 153° C. (Tf). Total time required was 45 min. The pH of the neutralized, dried product was 5.1. The total P content of this product was 15.72%. The number average chain length of the polyphosphate including orthophosphate (ñ′) was 1.64, number average chain length of the polyphosphate excluding orthophosphate (ñ) was 8.47, and the orthophosphate (OP) content was 55.88 wt % (Table 1). Compared to Example 8, the solubility of this product in NaHCO₃(Bicarbonate Assay) and Morgan's extractant (Morgan Assay) are much lower (around 52% of total P, Table 1). Fast heating reduces extent of evaporation and condensation (water loss from acid). The orthophosphate content of this product is also higher than with the product of Example 8 (Table 1).

### Example 39: Calcium Polyphosphate

The fertilizer of this example was prepared as in Examples 15 and 36, except that the acid temperature (Tp) was at 153° C.; after addition of CaO reaction exothermicity raised the liquid temperature to 156° C. (Te). The reactants were heated further to a final temperature of 158° C. (Tf). Total time of reaction was 85 min. The pH of the neutralized, dried product was 6.56. The product contained 22.2% Ca, 21.02% P and 0.62% Fe. In a Water Solubility Assay, the solubility of Ca from this product was 6.08% of the total Ca and 1.72% of the total P. When solubilities in NaHCO₃(Bicarbonate Assay) and Morgan's extractant (Morgan Assay) are compared there is no significant difference. Therefore, increasing Tf to 158° C. does not offer any advantage.

### Example 40: Calcium Polyphosphate

The fertilizer of this example was prepared as in Examples 15 and 39. Here, the acid was initially reacted to a temperature of 143° C. (Tp); after addition of CaO reaction exothermicity raised the liquid temperature to 151° C. (Te). The reactants were heated further to a final temperature of 155° C. (Tf). Total reaction period was 45 min. The pH of the neutralized, dried product was 6.37. The product contained 23.9% Ca, 20.95% P and 0.62% Fe. In a Water Solubility Assay, the solubility of P from this product was 1.27% of total P and the solubility of Ca from this product was 5.97% of the total Ca. In spite of temperatures being lower than those of examples 15, 35 and 39, the solubility of this product in NaHCO₃(Bicarbonate Assay) and Morgan's extractant (Morgan Assay) was not significantly different (Table 1). The number average chain length of the polyphosphate including orthophosphate (ñ′) was 1.58, number average chain length of the polyphosphate excluding orthophosphate (ñ) was 3.89, and the orthophosphate (OP) content was 50.68 wt % (Table 1). Orthophosphate content and OP/ñ′ values were also optimal (Table 1). Field trial assessment was conducted with this sample (FIGS. 1C and 1D). It shows significantly higher yields than the products of the Comparative Examples herein.

### Comparative Example 41: Calcium Polyphosphate Product

This example was to study the product described in WO2022/107085A1 (Example 1 paragraph 137) and compare it to the calcium polyphosphates of this disclosure. The calcium polyphosphate product was prepared according to the process of Example 1 of WO2022/107085A1. The total time period required was 60 min. The total P content of this product was 20.95%. The number average chain length of the polyphosphate including orthophosphate (ñ′) was 1.39, number average chain length of the polyphosphate excluding orthophosphate (ñ) was 9.83, and the orthophosphate (OP) content was 69 wt % (Table 1). The product had significantly lower solubility in NaHCO₃ (Bicarbonate Assay) and Morgan's extractant (Morgan Assay), 45.91 and 47.35, respectively, and also larger orthophosphate and OP/ñ′ values (Table 1) than Examples 15, 39 and 40.

### Comparative Example 42: Calcium Polyphosphate

This example was to study the product described in WO2022/107085A1 (Example 1 paragraph 137) and compare it the calcium polyphosphates of this disclosure; in this Comparative Example, a smaller batch size (⅓^{rd} the size used in Comparative Example 41) was used and the heating rate was faster. Temperatures (Tp and Tf) were the same as in WO2022/107085A1 (Example 1 paragraph 137). The total P content of this product was 20.95%. Total heating time was 45 min. This product had similar solubility in NaHCO₃(Bicarbonate Assay) and Morgan's extractant (Morgan Assay) as in Example 41. The solubilities were significantly lower than the solubilities of the calcium polyphosphates of this disclosure.

### Comparative Example 43: Calcium Polyphosphate

This example was to study the effect of producing calcium polyphosphate at lower temperatures and was similar to Example 40 in all other respects. Here the acid was preheated to 130° C. (Tp) and after addition of CaO, the reaction was stopped at 140° C. (Tf). The number average chain length of the polyphosphate including orthophosphate (ñ′) was 1.39, number average chain length of the polyphosphate excluding orthophosphate (ñ) was 5.73, and the orthophosphate (OP) content was 65.87 wt % (Table 1). Solubility of the product in NaHCO₃(Bicarbonate Assay) and Morgan's extractant (Morgan Assay) was lower than in Example 40; the orthophosphate content and OP/ñ′ values were also significantly higher (Table 1). Field trial assessment was conducted with this sample (FIG. 1D). Yields are lower with the calcium polyphosphate of this Comparative Example as compared to the products of this disclosure (Examples 40, 15).

### Comparative Example 44: Calcium Polyphosphate

This example was to study the product described in WO2022/107085A1 (Example 1 paragraph 137) and compare it to the calcium polyphosphates of this disclosure. The calcium polyphosphate product was prepared according to the process of Example 1 of WO2022/107085A1 with the exception that it was produced at slower heating rates. The total time period required was 90 min. The total P content of this product was 21.0%. The product had significantly lower solubility in NaHCO₃ (Bicarbonate Assay) and Morgan's extractant (Morgan Assay) compared to the products of this disclosure as in Examples 15, 39, and 40 (Table 1). Field trial assessment was conducted with this sample (FIG. 1c, 1d). Yields are lower with the product of WO2022/107085A1 compared to the products of this disclosure (Examples 40, 15).

### Example 45: Boron Polyphosphate

The boron polyphosphate of this disclosure was produced from phosphorus pentoxide (P₂O₅) and boric acid. When P₂O₅ is used instead of phosphoric acid, there is no requirement for heating. Since technical grade phosphoric acid is often produced from phosphorus pentoxide, this route to production of polyphosphates may be advantages for energy savings. Here, 50 g P₂O₅ was taken in a 1 L glass beaker and 10 mL water is added to it with stirring. Temperature of the liquid reached 160° C. due to the exothermic reaction with water. To the hot liquid, 21.8 g boric acid was added followed by and 10 mL water. The final reaction temperature noted was 160° C. Then a suspension of 100 g CaCO₃ in 125 mL water was added. It was dried at 70° C. and ground to pass through 180-micron sieve. The pH of the dried product was 6.41. The product contained 24.3% Ca, 13.8% P and 2.43% B. The number average chain length of the polyphosphate including orthophosphate (ñ′) was 1.65, number average chain length of the polyphosphate excluding orthophosphate (ñ) was 3.2, and the orthophosphate (OP) content was 42.86 wt % (Table 1). Amount of B solubilized in water from this product was 12.4% of total B. Solubility of this product in NaHCO₃(Bicarbonate Assay) and Morgan's extractant (Morgan Assay) was 58.94% and 59.16% respectively.

### Example 46: Molybdenum Polyphosphate

The molybdenum polyphosphate of this disclosure was produced from phosphorus pentoxide (P₂O₅) and molybdenum trioxide. As described in Example 44, this route to polyphosphate production might be advantageous for energy savings. Here, 10 g P₂O₅ was taken in a 50 mL glass beaker and 2 mL water is added to it with stirring. Then a suspension of 1.432 g of MoO₃ in2 mL water was added to the hot liquid with stirring. It was neutralized with a slurry of 18 g CaCO₃ in 2 mL water, dried at 70° C. and ground to pass through 180-micron sieve. The pH of the dried product was 6.68. The number average chain length of the polyphosphate including orthophosphate (ñ′) was 1.87, number average chain length of the polyphosphate excluding orthophosphate (ñ) was 4.63, and the orthophosphate (OP) content was 40.54 wt % (Table 1). The product had 3.54% Mo, 15.8% P and 17.7% Ca. The solubility of Mo in a Water Solubility Assay was 20% of the total Mo.

### Example 47: Manganese Polyphosphate

The manganese polyphosphate of this disclosure was produced from phosphorus pentoxide (P₂O₅) and manganous oxide. As described in Example 44, this route to polyphosphate production might be advantageous for energy savings. Here, 10 g P₂O₅ was taken in a 150 mL glass beaker and 9 mL water was added to it with stirring. Temperature of the liquid reached 110° C. due to the exothermic reaction with water. Then a suspension of 9 g of MnO in 22 mL water was added to the hot liquid with stirring. The liquid temperature at this stage was 93° C. It was neutralized with a slurry of 4 g magnesite in 10 mL water, dried at 70° C. and ground to pass through 180-micron sieve. The number average chain length of the polyphosphate including orthophosphate (ñ′) was 1.71, number average chain length of the polyphosphate excluding orthophosphate (ñ) was 9.8, and the orthophosphate (OP) content was 53.8 wt % (Table 1). Solubility of the product in NaHCO₃(Bicarbonate Assay) and Morgan's extractant (Morgan Assay) was high and the orthophosphate content and OP/ñ′ values were also optimal (Table 1).

### Example 48: Copper Polyphosphate

The copper polyphosphate of this disclosure was produced from phosphorus pentoxide (P₂O₅) and copper hydroxide carbonate (54% Cu). As described in example 44, this route to polyphosphate production might be advantageous for energy savings. Here, 10 g P₂O₅ was taken in a 150 mL glass beaker and 9 mL water was added to it with stirring. Temperature of the liquid reached 110° C. due to the exothermic reaction with water. Then a suspension of 9.69 g of copper hydroxide carbonate in 40 mL water was added to the hot liquid with stirring. The liquid temperature at this stage was 65° C. It was neutralized with a slurry of 10 g magnesite in 25 mL water, dried at 70° C. and ground to pass through a 180-micron sieve. The number average chain length of the polyphosphate including orthophosphate (ñ′) was 1.59, number average chain length of the polyphosphate excluding orthophosphate (ñ) was 4.56, and the orthophosphate (OP) content was 52.3 wt % (Table 1). Solubility of the product in NaHCO₃(Bicarbonate Assay) and Morgan's extractant (Morgan Assay) was high and the orthophosphate content and OP/ñ′ values were also optimal (Table 1).

### Examples 49 a-d: Zinc Polyphosphate

(a) The processes of these examples were similar to those in Examples 34 and 35; the difference was in the size of the batch (3 times larger) and in the neutralization. In a 5 L beaker phosphoric acid (1512 g, 61% P₂O₅) was taken. This was heated in an oil bath (initial temperature 160° C.) till the temperature of the liquid was 147° C. (Tp); time taken was 70 min. Then 636 g of ZnO (79.8% Zn) was added to it with stirring. The reaction was exothermic and the temperature of the liquid rose to 160° C. (Te=Tf) in 6 min. The beaker was removed from the oil bath. Total time of heating was 76 min. Then 222 mL water was added to the reactants in the beaker. This suspension is designated as (M). The contents were poured into a suspension of magnesite (423 g) in 600 mL water. This was a small reduction in the amount of magnesite added. The neutralized product was a semi-solid. It had a moisture content of 14.9%. It was further processed as described in Example 1. The pH of this product was 4.9.

(b) The reaction product was obtained as in (a) above. The suspension (M) was neutralized by pouring (M) into a suspension of 420 g magnesite and 66 g calcite in 800 mL water. The product became friable solid lumps in about 15 min. It had a moisture content of 18.4%. The pH of this product was 5.83.

(c) The reaction product was obtained as in (a) above. The suspension (M) was neutralized by pouring (M) into a suspension of 400 g magnesite and 134 g calcite in 800 mL water. It had a moisture content of 17.9%. The product remained semi-solid and showed separation of water. The pH of this product was 5.92.

(d) The reaction product was obtained as in (a) above. The product contained 15.96% P. The suspension (M) was neutralized by pouring (M) into a suspension of 390 g magnesite and 124 g calcite in 800 mL water. It had a moisture content of 20%. It was further processed as described in Example 1. This solidified to friable lumps. The pH of this product was 5.31.

### Examples 50: Zinc Polyphosphate

This process was similar to example 35 except that the temperatures Tp and Tf were different. Here, the acid was preheated to 155° C. (Tp) and then ZnO was added; the temperature initially rose to 162° C. and then dropped to 155° C. even though the beaker was still in the oil bath. Total time of heating was 85 min. It was neutralized and processed as in Example 35. The number average chain length of the polyphosphate including orthophosphate (ñ′) was 2.0, number average chain length of the polyphosphate excluding orthophosphate (ñ) was 7.54, and the orthophosphate (OP) content was 43 wt % (Table 1). Solubility of this product in NaHCO₃(Bicarbonate Assay) and Morgan's extractant (Morgan Assay) was high (Table 1).

### Examples 51 a-c: Zinc Polyphosphate

(a) The zinc polyphosphate of this disclosure was produced from phosphorus pentoxide (P₂O₅) and ZnO. As described in Example 44, this route to polyphosphate production might be advantageous for energy savings. Here, 10 g P₂O₅ was taken in a 150 mL glass beaker and 12 mL water was added to it with stirring. Temperature of the liquid reached 110° C. due to the exothermic reaction with water. Then 7.2 g of ZnO was added to the hot liquid with stirring. The liquid temperature at this stage was 118° C. It was neutralized with a slurry of 5 g magnesite in 10 mL water. The pH of the neutralized, dried product was 4.81. This was dried at 70° C. and ground to pass through 180-micron sieve. The number average chain length of the polyphosphate including orthophosphate (ñ′) was 1.87, number average chain length of the polyphosphate excluding orthophosphate (ñ) was 5.41, and the orthophosphate (OP) content was 42.9 wt % (Table 1).

(b) The process was the same as above, except that less water was added to P₂O₅ (9 mL). The number average chain length of the polyphosphate including orthophosphate (ñ′) was 1.65, number average chain length of the polyphosphate excluding orthophosphate (ñ) was 7.08, and the orthophosphate (OP) content was 54.0 wt % (Table 1).

(c) The process was the same as above, except that less water was added to P₂O₅ (8 mL).

The products had 21.5% Zn, 15.1% P and 9.2% Mg. Solubility of the products (a) in NaHCO₃(Bicarbonate Assay) and Morgan's extractant (Morgan Assay) was low but the products (b) and (c) had higher solubilities (Table 1); the orthophosphate content and OP/ñ′ values were also optimal (Table 1).

### Examples 52 a-b: Zinc Polyphosphate

(a) This process was similar to that described in Example 2, except that the acid used was of fertilizer grade phosphoric acid (“green acid”) of strength 51% P₂O₅. Green phosphoric acid contains impurities in the form of gypsum and organic matter. Here 590 g of green acid (51% P₂O₅) was taken in a beaker; 212 g ZnO was added to it at room temperature (Tp=28° C.). Temperature of the system rose to 108° C. due to exothermic reaction. When the beaker was placed in an oil bath (160° C.), there was a lot of frothing. The suspension started to thicken and stirring became difficult. Heating was continued till the temperature of the system was 130° C. Total time of heating was 40 min. It was not possible to heat the system beyond this temperature since the reactants in the beaker thickened to a mass that was not stirrable. The thickened material was mixed with 200 mL water and neutralized with magnesite suspension (150 g magnesite in 280 mL water). This was dried at 70° C. and ground to pass through 180-micron sieve.

(b) For comparative purposes, this process used preheated acid for carrying out the reaction. The green phosphoric acid was heated to 147° C. (Tp). There was foaming of the acid in the initial stages. After the addition of ZnO, the system was heated to a Tf of 158° C. and processed as described in Example 2. This example is to show that without preheating, higher polymerization temperatures cannot be achieved.

Example 52b: The process was similar to that in Example 52a, except that the green acid was preheated to 147° C. ZnO was added to this preheated acid. Exothermicity raised the temperature of the liquid to 155° C. A final Tf of 158° C. was obtained. The product was neutralized and processed as described in Example 52a.

### Examples 53: Calcium Polyphosphate

The calcium polyphosphate of this disclosure was produced from phosphorus pentoxide (P₂O₅) and calcium oxide. As described in Example 44, this route to polyphosphate production might be advantageous for energy savings. Here 10 g P₂O₅ was taken in a 150 mL glass beaker and 9 mL water was added to it with stirring. Temperature of the liquid reached 110° C. due to the exothermic reaction with water. To the hot liquid, a suspension of 0.2 g magnetite in 0.5 mL water was added with stirring followed by 2 g CaO, the reaction temperature noted was 95° C. Then 20 mL water was added to the system followed by 13 g CaCO₃. A solid product was obtained. This was dried at 70° C. and ground to pass through 180-micron sieve. The number average chain length of the polyphosphate including orthophosphate (ñ′) was 1.5, number average chain length of the polyphosphate excluding orthophosphate (ñ) was 3.6, and the orthophosphate (OP) content was 53.7 wt % (Table 1).

TABLE 1
Solubility of products in 0.1N NaHCO₃ (Bicarbonate Assay) and
Morgan's extractant (Morgan Assay) and chain length parameters

| | | | Number | | |
|---|---|---|---|---|---|
| | | | average | | |
| | | % P soluble | chain length | | |
| | % P soluble | in Morgan's | including | Ortho- | |
| | in NaHCO₃ | extractant | ortho- | phosphate | |
| | (Bicarbonate | (Morgan | phosphate | wt % | ratio |
| Example | Assay) | Assay) | (ñ′) | (OP) | OP/ñ′ |
| 1 | 57.45 | 59.56 | 1.6 | 56 | 35.00 |
| 2 | 52.82 | 54.02 | 1.72 | 53.3 | 31.01 |
| 3 | 57.62 | 58.68 | 1.78 | 50.8 | 28.54 |
| 4 | 55.16 | 54.90 | 1.68 | 54.1 | 32.20 |
| 5 | 58.08 | 58.40 | 1.72 | 49.2 | 28.60 |
| 6 | 54.81 | 55.31 | 1.62 | 53.5 | 33.02 |
| 7 | 48.71 | 50.23 | 1.46 | 59.3 | 40.62 |
| 8 | 57.79 | 59.52 | 1.82 | 50 | 27.47 |
| 9 | 58.71 | 59.73 | 1.98 | 43 | 21.72 |
| 10 | 57.69 | 57.88 | 1.95 | 45.61 | 23.39 |
| 11 | 58.69 | 59.07 | 1.78 | 50.8 | 28.54 |
| 12 | 57.59 | 58.29 | | | |
| 13 | 56.65 | 56.78 | | | |
| 14 | 56.41 | 56.79 | 1.77 | 49.1 | 27.74 |
| 15 | 59.80 | 59.23 | 1.57 | 53.85 | 34.30 |
| 16 | 60.12 | 59.52 | 1.84 | 48.1 | 26.14 |
| 17 | 59.97 | 59.64 | 1.6 | 55.1 | 34.44 |
| 18 | 60.52 | 59.28 | 1.87 | 42.9 | 22.94 |
| 19 | 55.52 | 56.60 | | | |
| 24 | 57.12 | 57.62 | | | |
| 25 | 57.23 | 58.65 | 1.72 | 52 | 30.23 |
| 26 | 56.19 | 57.34 | | | |
| 27 | 54.45 | 55.59 | | | |
| 28 | 54.37 | 55.25 | | | |
| 29 | 56.45 | 57.03 | | | |
| 30 | 57.42 | 58.19 | | | |
| 32 | 55.42 | 56.36 | | | |
| 33 | 56.21 | 57.48 | 1.71 | 42.6 | 24.9 |
| 34 | 58.11 | 58.53 | 1.96 | 45.1 | 23.0 |
| 35 | 58.17 | 58.95 | 1.95 | 45.61 | 23.4 |
| 36 | 57.79 | 59.08 | 1.65 | 54.17 | 32.83 |
| 37 | 56.08 | 57.58 | | | |
| 38 | 52.04 | 52.86 | 1.64 | 55.88 | 34.07 |
| 39 | 59.12 | 59.50 | | | |
| 40 | 58.19 | 58.38 | 1.58 | 50.68 | 32.07 |
| 45 | 58.94 | 59.16 | 1.65 | 42.86 | 25.98 |
| 46 | 58.84 | 59.02 | 1.87 | 40.54 | 21.68 |
| 47 | 59.17 | 59.70 | 1.71 | 53.8 | 31.46 |
| 48 | 60.21 | 61.14 | 1.59 | 52.3 | 32.89 |
| 49a | 55.95 | 57.02 | | | |
| 49b | 58.24 | 58.78 | | | |
| 49 | | 58.38 | | | |
| 49d | | 56.77 | | | |
| 50 | 59.44 | 60.54 | 2 | 43 | 21.5 |
| 51a | 54 | 53.34 | 1.87 | 42.9 | 22.94 |
| 51b | 56.57 | 55.18 | 1.65 | 54 | 32.73 |
| 51c | 51.00 | 52.45 | | | |
| 53 | 56.12 | 57.16 | 1.5 | 53.7 | 35.80 |

COMPARATIVE EXAMPLES

| | | | Number | | |
|---|---|---|---|---|---|
| | | | average | | |
| | | % P soluble | chain length | | |
| | % P soluble | in Morgan's | including | Ortho- | |
| | in NaHCO₃ | extractant | ortho- | phosphate | |
| Comparative | (Bicarbonate | (Morgan | phosphate | wt % | ratio |
| Example | Assay) | Assay) | (ñ′) | (OP) | OP/ñ′ |
| 20.1 | 26.86 | 26.67 | 2 | 0 | 0 |
| 20.2 | 27.71 | 26.10 | 3 | 0 | 0 |
| 20.3 | 32.31 | 34.07 | 1 | 100 | 100 |
| 20.4a | 34.02 | 36.43 | 1.51 | 59.84 | 39.63 |
| 20.4b | 46.80 | 48.16 | 1.48 | 62.28 | 42.08 |
| 20.4c | 38.01 | 39.66 | 1.45 | 63.39 | 43.72 |
| 20.4d | 40.95 | 40.85 | 1.46 | 62.71 | 42.95 |
| 20.4e | 42.18 | 41.87 | 1.41 | 65.79 | 46.66 |
| 20.4f | 34.38 | 34.83 | 1.33 | 69.14 | 51.98 |
| 20.4g | 48.31 | 46.82 | 1.41 | 64.71 | 45.89 |
| 20.4h | 48.82 | 48.52 | | | |
| 20.4i | 39.60 | 41.69 | | | |
| 20.4j | 34.77 | 35.92 | | | |
| 20.4k | 33.64 | 35.31 | | | |
| 20.4l | 31.15 | 32.93 | 1.28 | 72.73 | 56.82 |
| 20.5 | 29.46 | 31.36 | | | |
| 20.6a | 47.57 | 49.02 | 1.36 | 67.46 | 49.60 |
| 20.6b | 47.03 | 49.38 | | | |
| 20.6c | 45.77 | 47.13 | 1.37 | 67.21 | 49.06 |
| 20.6d | 45.04 | 44.82 | 1.41 | 65.83 | 46.69 |
| 20.6e | 43.98 | 45.05 | 1.4 | 65.15 | 46.53 |
| 20.6f | 42.61 | 44.76 | 1.41 | 70.69 | 50.13 |
| 20.6g | 44.27 | 46.3 | | | |
| 20.6h | | 41.52 | 1.29 | 72.81 | 56.44 |
| 20.6i | | 49.13 | | | |
| 20.6j | | 48.92 | | | |
| 20.6k | | 43.16 | | | |
| 20.7a | | 34.86 | | | |
| 20.7b | 32.13 | 33.87 | | | |
| 20.8a | 25.22 | 24.15 | 1 | 100 | 100 |
| 20.8b | 17.09 | 17.78 | 1 | 100 | 100 |
| 20.8c | 40.92 | 42.41 | 1 | 100 | 100 |
| 20.8d | 18.25 | 19.03 | 1 | 100 | 100 |
| 20.8e | 42.42 | 44.12 | 1 | 100 | 100 |
| 20.8f | 14.16 | 14.65 | 1 | 100 | 100 |
| 20.9 | 29.92 | 31.02 | 1 | 100 | 100 |
| 20.10 | 30.95 | 32.83 | 1.28 | 72.73 | 56.82 |
| 20.11a | | 36.47 | | | |
| 20.11b | | 36.12 | | | |
| 20.12 | 43.15 | 44.36 | 1.43 | 61.1 | 42.73 |
| 20.13 | | 36.16 | | | |
| 20.14 | | 46.95 | | | |
| 21 | 39.63 | 41.09 | 1.41 | 68.2 | 48.37 |
| 22 | 42.54 | 44.13 | 1.44 | 65.6 | 45.56 |
| 23 | 45.81 | 46.13 | 1.49 | 60.4 | 40.54 |
| 31 | 47.19 | 48.87 | | | |
| 41 | 45.91 | 47.35 | 1.39 | 69 | 49.64 |
| 42 | 46.25 | 47.78 | 1.42 | 66.96 | 47.15 |
| 43 | 46.11 | 47.01 | 1.39 | 65.87 | 47.39 |
| 44 | 46.74 | 47.69 | 1.4 | 68.27 | 48.76 |

### REFERENCES

1. Official Methods of Analysis of the AOAC (1990) Ed. F. Helrich Vol 1. 15^{th} edn. Arlington: Association of Official Analytical Chemists.
2. Lunt H A., Swanson C L W, Jacobson H G M (1958) The Morgan Soil Testing System. The Connecticut Experimental Agricultural Station.
3. Van Wazer, J. R.; Griffith, E. J.; Mccullough, J. F. (1954) Anal. Chem. 1954, 26:1755-1759.
4. U.S. Pat. No. 8,506,670
5. U.S. Pat. No. 9,017,443
6. PCT/IB2021/060786
7. Ray S K, Varadachari C and Ghosh K (1993) Ind. Eng. Chem. Res. 32:1218-1227.
8. Chandra P K, Varadachari C and Ghosh K (2009) Chem Eng J 155:451-456.
9. Ray S K, Varadachari C and Ghosh K (1997) J Ag Food Chem 45:1447-1453.
10. Van Wazer, J. R. 1966. Phosphorus and its Compounds. Vol. I. New York: Interscience.
11. Mendham, J., J. D. Barnes, and M. D. K. Thomas. 2006. Vogel's Textbook of Quantitative Chemical Analysis. London: Pearson Education.
12. J. A. Maxwell, Rock and Mineral Analysis, Interscience, New York, NY, USA, 1968.
13. Jeffrey, G H et al 1989. Vogel's Textbook of Quantitative Chemical Analysis, Wiley & Sons, NY
14. Bhattacharya I, Bandyopadhyay, S, Varadachari C & Ghosh K (2007) Ind Eng Chem Res 46:2870-2876.
15. Varadachari, C, Saha, S, Bandyopadhyay, S & Ghosh, K (2009) Mountain Res Develop 29:241-249.
16. Bandyopadhyay, S, Ghosh, K and Varadachari, C (2014) International Journal of Chemical Engineering 327153, 1-7.
17. Chandra P K, Varadachari C and Ghosh K (2009) A new slow-releasing iron fertilizer, Chemical Engineering Journal (UK) 155 451-456.
18. Ray S K, Varadachari C and Ghosh K (1997) Ind. Eng. Chem. Res. 45:1447-1453.

1. A polyphosphate composition comprising a basic cation selected from the group consisting of calcium, magnesium and combinations thereof and, optionally, a basic cation selected from the group consisting of K and NH₄⁺, and at least 0.1 wt %, combined total, of one or more micronutrients selected from the group consisting of Zn, B, Mn, Cu, and Mo wherein (i) the polyphosphate composition comprises 30 wt % to 60 wt % orthophosphate, (ii) has a number average chain length including orthophosphate (ñ′) of 1.5 to 2.2, and (iii) has a fraction of phosphorous in the polyphosphate composition that is soluble in a Morgan Assay of at least 50 wt % of the total amount of phosphorous in the polyphosphate composition.

2-3. (canceled)

4. The polyphosphate composition of claim 1 wherein the polyphosphate composition, has a ratio of OP to ñ′ in the range of 20:1 to 38:1, respectively, wherein (a) OP is the orthophosphate content of the polyphosphate composition expressed as a weight percentage of orthophosphate comprised by the polyphosphate and (b) ñ′ is the number average chain length of the polyphosphate composition including orthophosphate.

5-6. (canceled)

7. The polyphosphate composition of claim 1 wherein the polyphosphate composition contains no less than 1 wt % of the micronutrient(s).

8. (canceled)

9. The polyphosphate composition of claim 1 wherein the polyphosphate composition contains zinc.

10. The polyphosphate composition of claim 1 wherein the polyphosphate composition comprises boron.

11. The polyphosphate of claim 1 wherein the polyphosphate comprises manganese, iron, molybdenum, or copper.

12-14. (canceled)

15. The polyphosphate composition of claim 1 wherein the polyphosphate composition comprises at least 40 wt % orthophosphate.

16. The polyphosphate composition of claim 1 wherein the polyphosphate composition has a number average chain length including orthophosphate of at least 1.6.

17. The polyphosphate composition of claim 1 wherein the water-soluble fraction of the micronutrient(s) in the polyphosphate composition is less than 35 wt % of the total amount of the micronutrient(s) in the polyphosphate composition.

18-20. (canceled)

21. A polyphosphate composition comprising calcium as a basic cation and optionally one or more basic cations selected from the group consisting of Mg, K and NH₄⁺, and at least 0.1 wt %, combined total, of one or more micronutrients selected from the group consisting of Zn, Fe, B, Mn, Cu, and Mo wherein (i) the polyphosphate composition comprises 30 wt % to 60 wt % orthophosphate, (ii) has a number average chain length including orthophosphate (ñ′) of 1.5 to 2.2, and (iii) has a fraction of phosphorous in the polyphosphate composition that is soluble in a Morgan Assay of at least 50 wt % of the total amount of phosphorous in the polyphosphate composition.

22-23. (canceled)

24. The polyphosphate composition of claim 21 wherein the polyphosphate composition, has a ratio of OP to ñ′ in the range of 20:1 to 38:1, respectively, wherein (a) OP is the orthophosphate content of the polyphosphate composition expressed as a weight percentage of orthophosphate comprised by the polyphosphate and (b) ñ′ is the number average chain length of the polyphosphate composition including orthophosphate.

25. The polyphosphate composition of claim 21 wherein the polyphosphate composition comprises at least 8.5 wt % of the basic cation(s).

26. The polyphosphate composition of claim 21 wherein the polyphosphate composition contains no less than 0.5 wt % of the micronutrient(s).

27-28. (canceled)

29. The polyphosphate composition of claim 21 wherein the polyphosphate composition contains zinc.

30. The polyphosphate composition of claim 21 wherein the polyphosphate composition comprises boron.

31. The polyphosphate of claim 21 wherein the polyphosphate comprises manganese, iron, molybdenum, or copper.

32-34. (canceled)

35. The polyphosphate composition of claim 21 wherein the polyphosphate composition comprises at least 40 wt % orthophosphate.

36. The polyphosphate composition of claim 21 wherein the polyphosphate composition has a number average chain length including orthophosphate of at least 1.6.

37. The polyphosphate composition of claim 21 wherein the water-soluble fraction of the micronutrient(s) in the polyphosphate composition is less than 35 wt % of the total amount of the micronutrient(s) in the polyphosphate composition.

38-40. (canceled)
